(19) United States
(12) Patent Application Publication
(10) Pub. No.: US 2026/0278405 A1
(43) Pub. Date: Sep. 17, 2026

(54) RESOLUTION OF DOMAIN-SPECIFIC ISSUES

(71) Applicant: International Business Machines Corporation, Armonk, NY (US)

(72) Inventors: Ana Paula Appel, Sao Paulo (BR); Adriana Reigota Silva, Guarulhos (BR); Aline Bossi, Piracicaba (BR); Andrea Aparecida Crespo, Santo Andre (BR); Carlos Lessandro Lopes Rischioto, Sao Paulo (BR); Luiz Carlos Faray de Aquino, Sao Paulo (BR); Manuel Rocha Junior, Barueri (BR); Paula Fernanda Pereira, Sao Paulo (BR); Wilson Camargo Junior, Brasília (BR)

(21) Appl. No.: 19/076,743

(22) Filed: Mar. 11, 2025

(51) Int. Cl. G06N 5/022

(52) U.S. Cl. CPC G06N 5/022

(57) ABSTRACT

Resolution of domain-specific issues is provided and includes receiving response data for a plurality of queries. The plurality of queries is associated with an issue in a specific domain. A set of queries from the plurality of queries is identified and domain-specific data is retrieved from a set of knowledge bases associated with the specific domain. A set of responses is generated for the identified set of queries based on the retrieved domain-specific data. A first ML model is applied to the response data, the set of responses, and the plurality of queries. A set of solutions is generated to resolve the issue and an execution of at least a first solution of the generated set of solutions is controlled. The set of solutions is generated based on the application of the first ML model to the response data, the set of responses, and the plurality of queries.

### BACKGROUND

The disclosure relates to data processing and more particularly, to enhancement of data quality.

In recent years, the rapid development of information technology and the complexity of hardware and software infrastructures have driven a considerable evolution in the field of technical support systems. The demand for these technical support systems has increased as businesses depend more and more on digital technologies to improve the operations of these businesses. These technical support systems are currently employed across a wide range of industries, including information technology, telecommunications, and customer service. These systems typically allow users to submit tickets that detail the issues that the user faces, which are then assigned to support personnel for resolution.

Information technology, telecommunications, and customer service are just a few of the businesses that are depending more and more on these technical support systems. To handle user-reported complaints, businesses are implementing advanced ticketing systems, which manage organized problem tracking and resolution. Organizations are realizing that it is critical to optimize these systems in order to improve user experience and operational efficiency as the number of support requests keeps increasing.

### SUMMARY

In various embodiments of the disclosure, a computer-implemented method for resolution of domain-specific issues is described. The computer-implemented method includes receiving, by a computer, response data for a plurality of queries. The plurality of queries is associated with an issue in a specific domain. The computer-implemented method further includes identifying, by the computer, a set of queries from the plurality of queries based on the received response data. The computer-implemented method further includes retrieving, by the computer, domain-specific data from a set of knowledge bases associated with the specific domain. The domain-specific data is retrieved based on the identification of the set of queries. The computer-implemented method further includes generating, by the computer, a set of responses for the identified set of queries. The set of responses is generated based on the retrieved domain-specific data. The computer-implemented method further includes applying, by the computer, a first machine learning (ML) model of a set of ML models to the response data, the set of responses, and the plurality of queries. The computer-implemented method further includes generating, by the computer, a set of solutions to resolve the issue. The set of solutions is generated based on the application of the first ML model to the response data, the set of responses, and the plurality of queries. The computer-implemented method further includes controlling, by the computer, an execution of at least a first solution of the generated set of solutions.

In various embodiments of the disclosure, a computer system for resolution of domain-specific issues is described. The computer system includes a processor set, one or more computer-readable storage media, and program instructions stored on the one or more computer-readable storage media. The program instructions are executable by the processor set and cause the processor set to receive response data for a plurality of queries. The plurality of queries is associated with an issue in a specific domain. The program instructions further cause the processor set to identify a set of queries from the plurality of queries based on the received response data. The program instructions further cause the processor set to retrieve domain-specific data from a set of knowledge bases associated with the specific domain. The domain-specific data is retrieved based on the identification of the set of queries. The program instructions further cause the processor set to generate a set of responses for the identified set of queries. The set of responses is generated based on the retrieved domain-specific data. The program instructions further cause the processor set to apply a set of machine learning (ML) models to the response data, the set of responses, and the plurality of queries. The program instructions further cause the processor set to generate a set of solutions to resolve the issue. The set of solutions is generated based on the application of the set of ML models to the response data, the set of responses, and the plurality of queries. The program instructions further cause the processor set to control an execution of at least a first solution of the generated set of solutions.

In various embodiments of the disclosure, a computer-program product for resolution of domain-specific issues is described.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures, wherein:

FIG. 1 is a diagram that illustrates a computing environment for a resolution of domain-specific issues, in accordance with an embodiment of the disclosure;

FIG. 2 is a diagram that illustrates an environment for the resolution of domain-specific issues, in accordance with an embodiment of the disclosure;

FIG. 3 is a diagram that illustrates exemplary operations for the identification of queries for the resolution of domain-specific issues, in accordance with an embodiment of the disclosure;

FIG. 4 is a diagram that illustrates exemplary operations for the generation of solutions for the resolution of domain-specific issues, in accordance with an embodiment of the disclosure;

FIG. 5 is a diagram that illustrates exemplary operations for the execution of solutions for the resolution of domain-specific issues, in accordance with an embodiment of the disclosure;

FIG. 6 is a diagram that illustrates exemplary operations for training a machine learning (ML) model for the resolution of domain-specific issues, in accordance with an embodiment of the disclosure;

FIG. 7A is a diagram that illustrates an exemplary first user interface for the resolution of domain-specific issues, in accordance with an embodiment of the disclosure;

FIG. 7B is a diagram that illustrates an exemplary second user interface for the resolution of domain-specific issues, in accordance with an embodiment of the disclosure;

FIG. 7C is a diagram that illustrates an exemplary third user interface for the resolution of domain-specific issues, in accordance with an embodiment of the disclosure;

FIG. 7D is a diagram that illustrates an exemplary fourth user interface for the resolution of domain-specific issues, in accordance with an embodiment of the disclosure; and

FIG. 8 is a diagram that illustrates a flowchart of an exemplary method for the resolution of domain-specific issues, in accordance with an embodiment of the disclosure.

### DETAILED DESCRIPTION

The field of technical support systems has evolved significantly in recent years, driven by the rapid advancement of information technology and the growing complexity of software and hardware infrastructures. As organizations increasingly rely on digital solutions to enhance operations, the demand for effective technical support has increased. Technical support systems are currently employed across a wide range of industries, including information technology, telecommunications, and customer service. The technical support systems typically allow users to submit tickets that detail the issues that the user faces, which are then assigned to support personnel for resolution.

For instance, in corporate offices, the technical support systems play a critical role in maintaining productivity and ensuring that employees can effectively utilize the technology. The technical support systems are often employed to manage issues related to hardware malfunctions, software updates, and network connectivity problems. Employees can submit support tickets detailing the technical challenges that the employees face, which are then prioritized and assigned to IT personnel for resolution. This structured approach not only streamlines the troubleshooting process but also allows for the tracking of recurring issues, enabling organizations to identify patterns and implement preventive measures. By ensuring that technical problems are addressed promptly, the technical support systems help minimize downtime and maintain a smooth workflow within the office environment.

Furthermore, the technical support systems also help employees submit inquiries regarding various HR topics, such as benefits enrollment, payroll discrepancies, leave requests, and performance evaluations. By providing a centralized platform for the queries, organizations can streamline the communication process between employees and HR personnel, which not only ensures that employee concerns are documented and tracked but also allows HR teams to prioritize and respond to inquiries more efficiently. As a result, employees receive timely answers to the questions, which enhances the overall experience and satisfaction within the workplace.

However, one significant problem in the current technical support systems is the inconsistency and poor quality of data provided by users while submitting support tickets. Many users fail to include critical information, such as error codes, request types, details about the issue, or the context in which the problem occurred. This lack of detail complicates the troubleshooting process and increases the likelihood of miscommunication between users and support staff. For example, a user might report that “the application is not working,” without specifying which application or the nature of the malfunction, leaving support teams to guess the underlying issue.

Furthermore, the time-consuming nature of consolidating information from multiple sources is also a problem in the current technical support systems. When users provide incomplete or inaccurate descriptions, support staff often have to engage in back-and-forth communication to gather the critical details. This iterative process can lead to frustration for both users and support teams, as this iterative process prolongs the resolution timeline. For instance, a user may need to wait several hours or even days for a resolution, negatively impacting the productivity and satisfaction with the service. This inefficiency not only affects individual users but can also strain organizational resources and hinder overall service quality.

Finally, the reliance on human intervention to interpret inaccurate and incomplete user descriptions can introduce additional errors in the support process. Support staff may misinterpret the information provided, leading to incorrect diagnoses and solutions. For example, if a user describes a software failure as “the program is broken,” a support technician might assume that as a software bug rather than a compatibility issue with the user's operating system. Such misinterpretations can result in wasted time and resources, as well as a lack of trust in the support system. Therefore, there is a need for improved solutions for the resolution of these issues.

Traditional methods for the resolution of domain-specific issues face several difficulties. These traditional methods rely on continuous interactions between the users and the technical experts to first accurately complete the information about the issue, that was either present inaccurately or was incomplete in the data provided by the user, then generate the solutions to resolve the issue. Due to these continuous interactions, these methods are time-consuming, which used to increase the processing time for the resolution of the domain-specific issues. Furthermore, these traditional methods are prone to human errors due to the involvement of continuous interactions with the user. In most cases, the user may not be present every time for these continuous interactions, and also these continuous interactions may hinder the work of the user and the technical expert as well.

The disclosed system automatically obtains domain-specific data to complete the incomplete and inaccurate information from a set of knowledge bases. These set of knowledge bases contain the domain-specific data associated with different domains that may be utilized to complete the incomplete and inaccurate information associated with the issues. The domain-specific data corresponds to the data that is tailored to a particular field, industry, or area of expertise, making the data highly relevant and applicable for specific tasks, analyses, or decision-making processes within the specific domain. The disclosed system further correlates the obtained domain-specific data with the incomplete and inaccurate information to accurately complete the inaccurate and incomplete information. In an embodiment, the disclosed system utilizes machine learning techniques to correlate the domain-specific data with the incomplete and inaccurate information, which eliminates the chances of manual interventions and human errors while correlating the domain-specific data with the incomplete and inaccurate information. Hence, the disclosed system firstly ensures that the correlated information is accurate, complete, and free of any human errors by eliminating the need for manual interventions and the continuous interactions.

Generation of solutions using inaccurate and incomplete information may lead to inaccuracies in the solution, which may further lead to the issue not getting resolved. For example, the generated solutions may lack several critical steps in case the solutions are generated using the inaccurate and incomplete information, which may further lead to the issue not getting resolved. In case the issues are not resolved in the first iteration, this may lead to multiple iterations for the generation and execution of solutions, which might increase the processing time for the resolution of the issue. By completing the incomplete and inaccurate information, using the domain-specific data, the disclosed system ensures that the generated solutions are accurate, and the issues can be resolved. Accurate solutions refer to the solutions which can resolve the issue in the first iteration of their execution. Since, the disclosed system utilizes the correlated information (which is accurate, complete, and free of any human errors) to generate one or more solutions for the resolution of the issue, hence the disclosed system reduces the chances of any inaccuracies in the generation of the solutions, ensures that the generated one or more solutions are accurate and ensures that the issues are resolved in the first iteration.

The disclosed system further utilizes machine learning techniques for the generation of solutions. Applying the machine learning techniques on the inaccurate and incomplete information lead to an increase in processing time for the generation of the solutions since the machine learning techniques are dependent on identifying patterns and relationships between real-time data (e.g., the inaccurate and incomplete information) and the training data. In case the real-time data contains the inaccurate and incomplete information, the generated solutions would not only be inaccurate, the processing time for the generation of solutions would also be increased since identifying the patterns and relationships within the inaccurate and incomplete information is a time-consuming process. Hence, the disclosed system reduces the processing time for the generation of solutions by using the correlated information (that is accurate, complete, and free of human errors). Identifying the patterns and the relationships between the correlated data (which is accurate, complete, and free of human errors) would be a less time-consuming process as compared to identifying the patterns and the relationships within the inaccurate and incomplete information.

Continuing further, execution of the solutions that may be generated using the incomplete and inaccurate information may lead to the issue not getting resolved in the first iteration as discussed above. This might lead to an increase in the processing time for the resolution of the issue as there can be multiple iterations for the generation and execution of the solutions and there might be a possibility that the issue may not get resolved even after the multiple iterations (in case the provided information is incomplete and inaccurate). By ensuring that the one or more solutions are generated using the correlated information (that is accurate, complete, and free of human errors), the disclosed system firstly ensures that the one or more solutions generated by the disclosed system includes all the critical steps that are needed to resolve the issue. By ensuring that the one or more solutions generated by the disclosed system include all the critical steps for the resolution of the issue, the disclosed system further ensures that by controlling the execution of at least a first solution of the generated one or more solutions resolves the issue in the first iteration. The disclosed system further controls the execution of at least a first solution of the generated one or more solutions to resolve the issue. Since the disclosed system eliminates the need for the generation and execution of solutions in the multiple iterations, hence the disclosed system reduces the processing time for the resolution of the issue by ensuring that the at least first solution of the generated one or more solutions resolves the issue in the first iteration.

Further, since the disclosed system automates the entire process of the resolution of the issue and eliminates the need for manual interventions, the disclosed system improves the user experience. The disclosed system eliminates the need for continuous interactions between the users and the technical experts by completing the incomplete and inaccurate information about the issues using the domain-specific data of the issues. Hence, by eliminating the need for continuous interactions, the disclosed system reduces the processing time of the process of resolution of domain-specific issues and further makes the process more accurate by eliminating the possibility of human errors by directly obtaining the domain-specific information from the one or more knowledge bases based on the application of the set of ML models.

The disclosed system can further be implemented as a value-added service for organizations that use these technical support systems to manage the employees. For instance, the disclosed system can be used in corporate offices to help the user and the technical experts in order to streamline the process of issue resolution. The disclosed system further reduces the load on technical experts and the users to engage in continuous interactions for the resolution of the issues. These users and the technical experts can then focus on the main work instead of wasting the time engaging in continuous interactions.

The disclosed system further maintains data integrity by relying on trusted data sources associated with the organization (for which the disclosed system is implemented as a value added service) to obtain the domain-specific data and then complete the incomplete and inaccurate information. Hence, the disclosed system further resolves the privacy concerns of the organizations by maintaining data integrity, which in today's day and age is one of the most critical factors.

In various embodiments of the disclosure, a computer-implemented method for resolution of domain-specific issues is described. The computer-implemented method includes receiving, by a computer, response data for a plurality of queries. The plurality of queries is associated with an issue in a specific domain. The computer-implemented method further includes identifying, by the computer, a set of queries from the plurality of queries based on the received response data. The computer-implemented method further includes retrieving, by the computer, domain-specific data from a set of knowledge bases associated with the specific domain. The domain-specific data is retrieved based on the identification of the set of queries. The computer-implemented method further includes generating, by the computer, a set of responses for the identified set of queries. The set of responses is generated based on the retrieved domain-specific data. The computer-implemented method further includes applying, by the computer, a first machine learning (ML) model of a set of ML models to the response data, the set of responses, and the plurality of queries. The computer-implemented method further includes generating, by the computer, a set of solutions to resolve the issue. The set of solutions is generated based on the application of the first ML model to the response data, the set of responses, and the plurality of queries. The computer-implemented method further includes controlling, by the computer, an execution of at least a first solution of the generated set of solutions.

In various embodiments of the disclosure, the computer-implemented method further includes determining, by the computer, a set of likelihood values associated with the set of solutions. Each likelihood value of the set of likelihood values is indicative of a likelihood of a corresponding solution of the set of solutions to resolve the issue. The computer-implemented method further includes arranging, by the computer, the generated set of solutions based on the determined set of likelihood values. The computer-implemented method further includes selecting, by the computer, at least the first solution of the generated set of solutions based on the arrangement. The computer-implemented method further includes controlling, by the computer, the execution of at least the selected first solution of the generated set of solutions.

In various embodiments of the disclosure, the computer-implemented method further includes applying, by the computer, a second ML model of the set of ML models to the response data. The computer-implemented method further includes identifying, by the computer, the set of queries from the plurality of queries based on the application of the second ML model to the response data. A response of each query of the set of queries is absent in the received response data.

In various embodiments of the disclosure, the computer-implemented method further includes applying, by the computer, a second ML model of the set of ML models to the response data. The computer-implemented method further includes identifying, by the computer, the set of queries from the plurality of queries based on the application of the second ML model to the response data. A response, in the received response data, of each query of the set of queries is inaccurate.

In various embodiments of the disclosure, the computer-implemented method further includes applying, by the computer, a second ML model of the set of ML models to the plurality of queries. The computer-implemented method further includes determining, by the computer, a quality score associated with each query of the plurality of queries based on the application of the second ML model to the plurality of queries. The computer-implemented method further includes identifying, by the computer, the set of queries from the plurality of queries based on the quality score.

In various embodiments of the disclosure, the computer-implemented method further includes comparing, by the computer, the quality score associated with each query of the plurality of queries with a threshold quality score. The computer-implemented method further includes identifying, by the computer, the set of queries from the plurality of queries based on the comparison.

In various embodiments of the disclosure, the computer-implemented method further includes identifying, by the computer, a first subset of queries from the set of queries based on the retrieved domain-specific data. The computer-implemented method further includes applying, by the computer, a second ML model of the set of ML models to the first subset of queries and the domain-specific data. The computer-implemented method further includes generating, by the computer, a first subset of responses for the first subset of queries based on the application of the second ML model to the first subset of queries and the domain-specific data. The set of responses includes the first subset of responses.

In various embodiments of the disclosure, the computer-implemented method further includes identifying, by the computer, a second subset of queries from the set of queries based on the retrieved domain-specific data. The first subset of queries is different from the second subset of queries. The computer-implemented method further includes receiving, by the computer, feedback data associated with the second subset of queries. The computer-implemented method further includes generating, by the computer, a second subset of responses for the second subset of queries based on the feedback data. The set of responses includes the second subset of responses.

In various embodiments of the disclosure, the computer-implemented method further includes retrieving, by the computer, a training dataset including a plurality of historical issues and a plurality of historical solutions associated with the plurality of historical issues. Each historical solution of the plurality of historical solutions is associated with a resolution of a corresponding historical issue of the plurality of historical issues. The plurality of historical issues is inclusive of the issue and the plurality of historical solutions is inclusive of the set of solutions. The computer-implemented method further includes training, by the computer, the first ML model based on the training dataset.

In various embodiments of the disclosure, a computer system for resolution of domain-specific issues is described. The computer system includes a processor set, one or more computer-readable storage media, and program instructions stored on the one or more computer-readable storage media. The program instructions are executable by the processor set and cause the processor set to receive response data for a plurality of queries. The plurality of queries is associated with an issue in a specific domain. The program instructions further cause the processor set to identify a set of queries from the plurality of queries based on the received response data. The program instructions further cause the processor set to retrieve domain-specific data from a set of knowledge bases associated with the specific domain. The domain-specific data is retrieved based on the identification of the set of queries. The program instructions further cause the processor set to generate a set of responses for the identified set of queries. The set of responses is generated based on the retrieved domain-specific data. The program instructions further cause the processor set to apply a set of machine learning (ML) models to the response data, the set of responses, and the plurality of queries. The program instructions further cause the processor set to generate a set of solutions to resolve the issue. The set of solutions is generated based on the application of the set of ML models to the response data, the set of responses, and the plurality of queries. The program instructions further cause the processor set to control an execution of at least a first solution of the generated set of solutions.

In various embodiments of the disclosure, the program instructions further cause the processor set to determine a set of likelihood values associated with the generated set of solutions. Each likelihood value of the set of likelihood values is indicative of a likelihood of a corresponding solution of the set of solutions to resolve the issue. The program instructions further cause the processor to arrange the generated set of solutions based on the determined set of likelihood values. The program instructions further cause the processor set to select at least the first solution of the generated set of solutions based on the arrangement. The program instructions further cause the processor set to control the execution of at least the selected first solution of the generated set of solutions.

In various embodiments of the disclosure, the program instructions further cause the processor set to apply the set of ML models to the response data. The program instructions further cause the processor set to identify the set of queries from the plurality of queries based on the application of the set of ML models to the response data. A response of each query of the set of queries is absent in the received response data.

In various embodiments of the disclosure, the program instructions further cause the processor set to apply the set of ML models to the response data. The program instructions further cause the processor set to identify the set of queries from the plurality of queries based on the application of the set of ML models to the response data. A response, in the received response data, of each query of the set of queries is inaccurate.

In various embodiments of the disclosure, the program instructions further cause the processor set to apply the set of ML models to the plurality of queries. The program instructions further cause the processor set to determine a quality score associated with each query of the plurality of queries based on the application of the set of ML models to the plurality of queries. The program instructions further cause the processor set to identify the set of queries from the plurality of queries based on the quality score.

In various embodiments of the disclosure, the program instructions further cause the processor set to compare the quality score associated with each query of the plurality of queries with a threshold quality score. The program instructions further cause the processor set to identify the set of queries from the plurality of queries based on the comparison.

In various embodiments of the disclosure, the program instructions further cause the processor set to identify a first subset of queries from the set of queries based on the retrieved domain-specific data. The program instructions further cause the processor set to apply the set of ML models to the first subset of queries and the domain-specific data. The program instructions further cause the processor set to generate a first subset of responses for the first subset of queries based on the application of the set of ML models to the first subset of queries and the domain-specific data. The set of responses includes the first subset of responses.

In various embodiments of the disclosure, the program instructions further cause the processor set to identify a second subset of queries from the set of queries based on the retrieved domain-specific data. The first subset of queries is different from the second subset of queries. The program instructions further cause the processor set to receive feedback data associated with the second subset of queries. The program instructions further cause the processor set to generate a second subset of responses for the second subset of queries based on the feedback data. The set of responses includes the second subset of responses.

In various embodiments of the disclosure, the program instructions further cause the processor set to retrieve a training dataset including a plurality of historical issues and a plurality of historical solutions associated with the plurality of historical issues. Each historical solution of the plurality of historical solutions is associated with a resolution of a corresponding historical issue of the plurality of historical issues. The plurality of historical issues is inclusive of the issue and the plurality of historical solutions is inclusive of the generated set of solutions. The program instructions further cause the processor set to train the set of ML models based on the training dataset.

In various embodiments of the disclosure, a computer-program product for generation of a set of solutions to resolve an issue in a specific domain is described. The computer program product includes one or more computer-readable storage media and program instructions stored in the one or more computer-readable storage media to perform operations that include receiving response data for a plurality of queries. The plurality of queries is associated with the issue in the specific domain. The operations further include identifying a set of queries from the plurality of queries based on the received response data. The operations further include retrieving domain-specific data from a set of knowledge bases associated with the specific domain. The domain-specific data is retrieved based on the identification of the set of queries. The operations further include generating a set of responses for the identified set of queries. The set of responses is generated based on the retrieved domain-specific data. The operations further include applying a machine learning (ML) model to the response data, the set of responses, and the plurality of queries. The operations further include generating the set of solutions to resolve the issue. The set of solutions is generated based on the application of the ML model to the response data, the set of responses, and the plurality of queries. The operations further include controlling an execution of at least a first solution of the generated set of solutions.

In various embodiments of the disclosure, the operations further include determining a set of likelihood values associated with the set of solutions. Each likelihood value of the set of likelihood values is indicative of a likelihood of a corresponding solution of the set of solutions to resolve the issue. The operations further include arranging the set of solutions based on the determined set of likelihood values. The operations further include selecting at least the first solution of the set of solutions based on the arrangement. The operation further includes controlling the execution of at least the selected first solution of the generated set of solutions.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage media is an electronic storage media, a magnetic storage media, an optical storage media, an electromagnetic storage media, a semiconductor storage media, a mechanical storage media, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage media or mediums, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while stored.

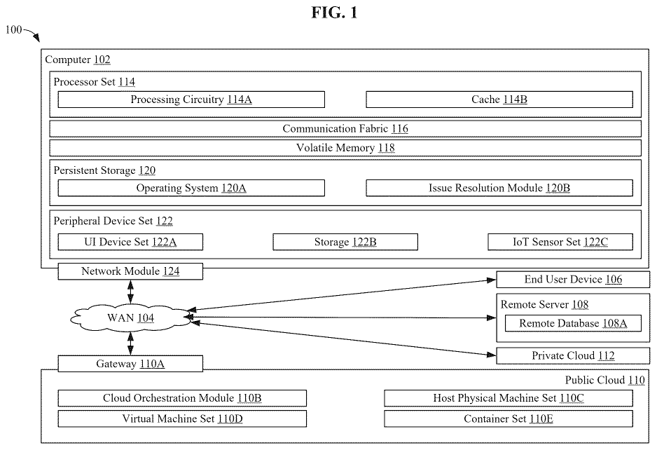

FIG. 1 is a diagram that illustrates a computing environment for the resolution of domain-specific issues, in accordance with an embodiment of the disclosure. With reference to FIG. 1, there is shown a computing environment 100 that contains an example of an environment for the execution of at least some of the computer code involved in performing the disclosed methods, such as an issue resolution module 120B. In addition to the issue resolution module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the issue resolution module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that is for running a program, accessing a network or querying a database, such as a remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though not shown in a cloud in FIG. 1.

The processor set 114 includes one or more computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the issue resolution module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not utilized unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the issue resolution module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is utilized to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running inside. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

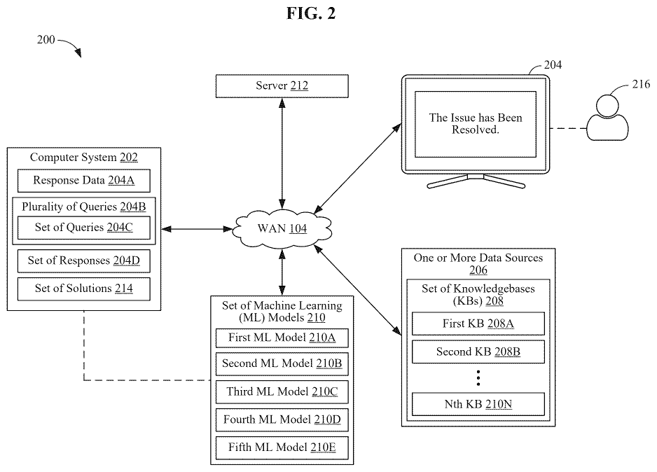

FIG. 2 is a diagram that illustrates an environment for the resolution of domain-specific issues, in accordance with an embodiment of the disclosure. FIG. 2 is explained in conjunction with elements from FIG. 1. With reference to FIG. 2, there is shown a diagram of a network environment 200. The network environment 200 includes a computer system 202 (may be referred to a system 202, hereinafter), a user device 204, and one or more data sources 206. The one or more data sources 206 include a set of knowledge bases (KBs) 208. The set of KBs 208 further includes a first KB 208A, a second KB 208B, up to Nth KBs. The network environment 200 further includes a set of ML models 210 and a server 212. The set of ML models 210 includes a first ML model 210A, a second ML model 210B, a third ML model 210C, a fourth ML model 210D, and a fifth ML model 210E. The user device 204 is associated with a user 216. The network environment 200 further includes the WAN 104 of FIG. 1. In an embodiment, the user device 204 is an exemplary embodiment of the EUD 106. Similarly, the computer system 202 is an exemplary embodiment of the computer 102 in FIG. 1.

The computer system 202 includes suitable logic, circuitry, code, and/or interfaces for the resolution of domain-specific issues. The system 202 is configured to receive response data 204A for a plurality of queries 204B. The plurality of queries 204B is associated with an issue in a specific domain. The system 202 is further configured to identify a set of queries 204C from the plurality of queries 204B based on the received response data 204A. The system 202 is further configured to retrieve domain-specific data from the set of knowledge bases (KBs) 208 associated with the specific domain. The domain-specific data is retrieved based on the identification of the set of queries 204C. The system 202 is further configured to generate a set of responses 204D for the identified set of queries 204C. The set of responses 204D is generated based on the retrieved domain-specific data. The system 202 is further configured to apply the first ML model 210A of the set of machine learning (ML) models 210 to the response data 204A, the set of responses 204D, and the plurality of queries 204B. The system 202 is further configured to generate a set of solutions 214 to resolve the issue. The set of solutions 214 is generated based on the application of the first ML model 210A of the set of ML models 210 to the response data 204A, the set of responses 204D, and the plurality of queries 204B. The system 202 is further configured to control an execution of at least a first solution of the generated set of solutions 214.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the computer system 202 may be embodied as a cloud-based service, a cloud-based application, a cloud-based platform, a remote server-based service, a remote server-based application, a remote server-based platform, or a virtual computing system.

The user device 204 includes suitable logic, circuitry, code, and/or interfaces that are configured to perform one or more operations within the network environment 200. In an embodiment, the user device 204 is configured to perform the one or more operations such as receiving data, transmitting the data, and rendering the data. In an embodiment, the system 202 is configured to receive the response data 204A for the plurality of queries 204B from the user device 204. In an alternate embodiment, the system 202 is further configured to control the execution of the at least first solution of the generated set of solutions on the user device 204.

In an alternate embodiment, the system 202 is further configured to render a message on the user device 204 upon the execution of the at least first solution. The message may be, for example, “The issue has been resolved”. Examples of the user device 204 include but are not limited to, a computer workstation, a laptop, a smartphone, a cellular phone, a mobile phone, a consumer electronic (CE) device, an Internet of Things (IoT) device, a computing device, or the like.

Each data source of the one or more data sources 206 corresponds to an organized collection of data that may be stored and accessed electronically from a computer system (such as the computer system 202). Each of the one or more data sources 206 may be designed to manage, store, retrieve, and update data efficiently. In an exemplary implementation, each data source of the one or more data sources 206 may correspond to a database. In such an implementation, the structure of the database corresponding to each data source of the one or more data sources 206 typically involves tables, records, and fields that can be managed through various database management systems (DBMS). Examples of each data source of one or more data sources 206 may include but are not limited to, a relational database, a Non-Structured Query Language (SQL) database, a hierarchical database, a network database, a transactional database, a data warehouse, and a distributed database. In an embodiment, each data source of the one or more data sources 206 is connected to application programming interfaces (APIs) of a specific organization, for which the system 202 can be implemented as a value-added service.

In an embodiment, each data source of the one or more data sources 206 is configured to store the set of KBs 208 associated with the specific domain. Each knowledge base of the set of knowledge bases 208 corresponds to a structured repository or a structured database of information that encompasses facts, concepts, and relationships within a specific domain. Each KB of the set of KBs 208 serves as a centralized source of knowledge that can be queried and utilized for various applications, such as data completion, natural language processing, and decision-making. For example, in the medical domain, a knowledge base might include information about diseases, symptoms, treatments, and interrelations, allowing healthcare professionals to access relevant data quickly.

In an embodiment, each KB of the set of KBs 208 stores the domain-specific data associated with the specific domain. In an embodiment, the domain-specific data corresponds to the data that is tailored to a particular field, industry, or area of expertise, making the data highly relevant and applicable for specific tasks, analyses, or decision-making processes within that domain. The domain-specific data is characterized by its specificity, depth, and contextual relevance, which is obtained through research and operational activities within the specific domain. For example, in the healthcare domain, the domain-specific data include various medical records, treatment protocols, and various clinical trial results, which are critical for healthcare providers to make informed decisions about patient care and treatment options. In the Information Technology (IT) domain, the domain-specific data may include network configurations, system logs, cybersecurity threat intelligence, and performance metrics, which may be critical for IT professionals to ensure system uptime, optimize performance, and protect against cyber threats. In the finance domain, the domain-specific data includes market reports, news articles, analyst research, financial statements, and economic indicators, which may be critical for financial analysts to interpret financial statements and grasp the specific language used in financial reporting.

The first ML model 210A of the set of ML models 210 corresponds to a neural network-based regression model. The neural network is a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of the nodes in the input layer may be coupled to at least one node of the hidden layer(s). Similarly, the inputs of each hidden layer are coupled to outputs of at least one node in various layers of the neural network. Outputs of each hidden layer may be coupled to inputs of at least one node in the various layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on the training dataset. Each node of the neural network corresponds to a mathematical function (e.g., a sigmoid 2 function or a rectified linear unit) with a set of parameters, tunable during the training of the neural network. The set of parameters includes, for example, a weight parameter, a regularization parameter, and the like. Each node uses the mathematical function to compute an output based on one or more inputs from nodes in various layer(s) (e.g., previous layer(s)) of the neural network. The nodes of the neural network correspond to the same or a different mathematical function.

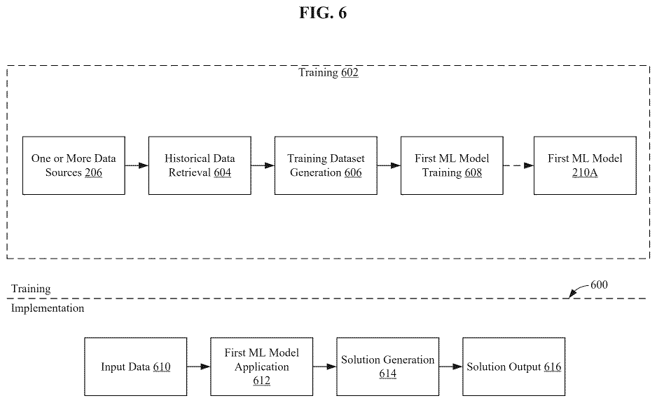

In the training of the first ML model 210A of the set of ML models 210, one or more parameters of each node of the first ML model 210A of the set of ML models 210 may be updated based on whether an output of the final layer for a given input (from the training dataset) matches an accurate result based on a loss function for the first ML model 210A of the set of ML models 210. The above process may be repeated for the same or a different input until a minima of loss function may be achieved, and a training error may be minimized. Details about the training of the first ML model 210A of the set of ML models 210 are provided, for example, in FIG. 6.

The neural network includes electronic data, such as, for example, a software program, code of the software program, libraries, applications, scripts, or various logics or instructions for execution by a processing device, such as circuitry. The neural network may be implemented using hardware including a processor, a microprocessor (e.g., to perform or control the performance of one or more operations), a field-programmable gate array (FPGA), or an application-specific integrated circuit (ASIC). Alternatively, in some embodiments, the neural network may be implemented using a combination of hardware and software. Accordingly, in some embodiments, the first ML model 210A of the set of ML models 210 is a separate entity in the computer system 202, without deviation from the scope of the disclosure.

In an embodiment, the first ML model 210A of the set of ML models 210 is configured to predict the set of solutions to resolve the issue based on the response data 204A, the set of responses 204D, and the plurality of queries 204B. In an embodiment, the computer system 202 is configured to train the first ML model 210A of the set of ML models 210 to generate the set of solutions. For example, in case of an Information Technology (IT) domain-specific issue “Email-Login Issue”, the first ML model 210A predicts a set of solutions “1. Verify the user's role and permissions. 2. Update the user's access rights in the system. 3. Confirm the user can access the application”. Details about the training of the first ML model 210A are provided, for example, in FIG. 6.

Examples of the first ML model 210A of the set of ML models 210 include one of but are not limited to, an artificial neural network (ANN), a deep neural network (DNN), a convolutional neural network (CNN), a fully connected neural network, and/or a combination of such networks.

Apart from the first ML model 210A, each ML model of the set of ML models 210 may be a sophisticated piece of software that leverages natural language processing (NLP) and machine learning techniques to understand, generate, and manipulate human language. For example, each of the second ML model 210B, the third ML model 210C, the fourth ML model 210D, and the fifth ML model 210E may correspond to a language model or a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction.

Further, the LLM may be a type of ML model specifically designed to understand, generate, and manipulate human language on a large scale. LLMs may leverage machine learning techniques, particularly those based on deep learning architectures, to process and comprehend natural language. LLMs have gained prominence for the ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

For example, the LLMs may be considered to be built on Transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. For example, the LLMs may generate contextual representations of words, meaning that the representation of a word is influenced by its surrounding context. This enables the model to capture the meaning of words in different contexts. Examples of the LLMs include, but are not limited to, GPT (generative pre-train transformers) and BERT (Bi-directional Encoder representations from transformers).

Recently, the use of LLMs has increased manifold for a variety of language-related tasks, such as sentiment analysis, text classification, question answering, machine translation, summarization, and conversational agents. Due to a large number of parameters, training of LLMs from scratch is a time-consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing the model to learn general linguistic features. However, for performing domain-specific tasks, adaptation of LLMs for the particular domain needs to be performed. In one example, LLMs may leverage transfer learning where the model is pre-trained on a large corpus of data and then fine-tuned for specific tasks or domains. This approach enables the model to transfer the knowledge gained during pre-training to various downstream applications.

It may be noted that a base model in an LLM refers to a trained model that has been trained on a large corpus of data for a general natural language understanding and generation task. The trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

For example, the base model contains a large number of parameters and exhibits a high level of language understanding, making the base model a powerful starting point for a variety of natural language processing tasks. While the base model is pre-trained on a large corpus of general language data, fine-tuning or adapting the base model for specific tasks or domains enhances its performance and makes the base model more suitable for targeted applications.

Continuing further, an adapter refers to a smaller and task-specific module added to the base model to adapt the base model for a particular task or domain. The adapter includes a lightweight set of parameters that is trained on task-specific data while keeping the base model's parameters frozen. In particular, the adapter is used to fine-tune the base model for a specific downstream task without extensively modifying its pre-trained parameters. This approach is beneficial when computational resources or labeled task-specific data are limited.

In an embodiment, the second ML model 210B is configured to identify the set of queries 204C from the plurality of queries 204B. The set of queries may include the queries for which the responses are absent in the response data 204A. For example, in case the response data includes a response of six queries from ten queries, then the second ML model 210B is configured to identify those four queries whose response is absent in the response data. In an embodiment, the third ML model 210C is configured to identify the set of queries from the plurality of queries 204B. In an embodiment, the responses to the identified set of queries, in the response data 204A, may be inaccurate. For example, in case the response of two queries in the response data is inaccurate, the third ML model 210C is configured to identify those two queries from the plurality of queries.

In an embodiment, a response is considered inaccurate if it falls outside a threshold range from the established ground truth. For instance, in the context of information technology, consider the query: “What is the software version of application XYZ?”. If the response provided is “XYZ”, this is considered inaccurate because it refers to the name of the application rather than the required version number. The expected response should be a numerical value representing the software version, rather than a character string. The third ML model 210C further includes this query in the set of queries. In an example related to healthcare, if the query is “What is the patient's current medication dosage?” and the response is “Aspirin” which is the name of the medication instead of the dosage, then this response is considered inaccurate, and the third ML model 210C includes the query in the identified set of queries.

In an embodiment, the fourth ML model 210D is configured to determine the quality score of the response for each query of the plurality of queries 204B in the response data 204A. In an embodiment, the fourth ML model 210D analyzes the response of each query of the plurality of queries 204B and then determines the quality score based on the analysis. The quality score of the response is a parameter that indicates how well the response addresses the corresponding query. The quality score of the response may indicate various factors such as correctness, clarity, and comprehensiveness of the response to address the corresponding query. In an embodiment, the fifth ML model 210E is configured to generate the set of responses for the identified set of queries (the queries whose responses in the response data 204A are either absent or inaccurate).

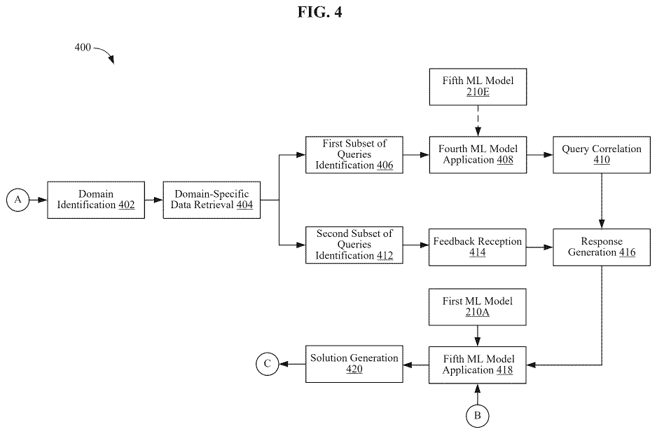

In an embodiment, the fifth ML model 210E is configured to generate the set of responses for the identified set of queries (the queries whose responses in the response data 204A are either absent or inaccurate). Details about the generation of the set of responses are provided, for example, in FIG. 4. In an embodiment, the computer system 202 is configured to store each ML model of the set of ML models 210. In an alternate embodiment of the disclosure, each ML model of the set of ML models 210 is embodied as a separate entity that is implemented as a set of distributed cloud-based resources by use of several technologies that are well known to those ordinarily skilled in the art.

The server 212 includes suitable logic, circuitry, interfaces, and/or code that can be implemented as a cloud server and may execute operations through web applications, cloud applications, HTTP requests, repository operations, file transfer, and the like. Various implementations of the server 212 include but are not limited to, a database server, a file server, a web server, a media server, an application server, a mainframe server, or a cloud computing server. In an embodiment, the server 212 is configured to store the response data 204A, the plurality of queries 204B, the set of queries 204C, the set of responses 204D, and the set of solutions 214.

The issue refers to any problem that the user 216 may be facing in the specific domain (e.g., while working on an application within the IT domain, the user may face login issues). In case of the healthcare domain, the issue may refer to a problem that a healthcare provider may be facing (e.g., a doctor using an electronic health record system may encounter inaccurate or missing patient data). In case of the finance domain, the issue refers to a problem that a financial analyst may be facing (e.g., while using a financial modeling application, the analyst may encounter inconsistencies in data from different sources). The plurality of queries 204B includes one or more questions for the user 216 about the issue that the user 216 may be facing. In an embodiment, the response data 204A indicates the response of the user 216 to the plurality of queries 204B, and the response data 204A includes one or more responses to the plurality of queries 204B associated with the issue. The one or more responses include the information that can be utilized to generate the set of solutions to resolve the issue present within the specific domain.

The set of queries 204C includes one or more queries from the plurality of queries 204B. The responses to the set of queries, in the response data 204A, may be either absent or inaccurate. The generated set of responses 204D are the responses (generated by the system 202) to the set of queries 204C (whose responses, in the response data 204A, are either absent or inaccurate). The generated set of solutions 214 includes a series of operations (generated by the system 202) that need to be executed to resolve the issue.

In an embodiment, the server 212 is implemented as a plurality of distributed cloud-based resources by use of several technologies that are well known to those ordinarily skilled in the art. A person with ordinary skill in the art will understand that the scope of the disclosure may not be limited to the implementation of the server 212 and the computer system 202 as two separate entities. In certain embodiments, the functionalities of the server 212 can be incorporated in its entirety or at least partially in the computer system 202, without a departure from the scope of the disclosure.

In operation, the system 202 is configured to receive response data 204A for the plurality of queries 204B, from the user device 204. The plurality of queries 204B is associated with the issue in the specific domain. The issue refers to any problem that the user 216 may be facing in the specific domain (e.g., while working on an application within the IT domain, the user may face login issues). The plurality of queries 204B includes the one or more questions for the user 216 about the issue that the user 216 may be facing. In an embodiment, the response data 204A indicates the response of the user 216 to the plurality of queries 204B, and the response data 204A includes the one or more responses to the plurality of queries 204B associated with the issue. The one or more responses include the information that can be utilized to generate the set of solutions to resolve the issue present within the specific domain. In an embodiment, in case an issue is detected, the system 202 is configured to generate and render a template on the user device 204 to obtain information about the issue. The template includes the plurality of queries related to the issue within the specific domain to obtain the response data 204A.

By way of example and not by limitation, the system receives the response data 204A for an issue within the “IT domain”. The response data includes the one or more responses to the plurality of queries. The response data can be represented in Table 1 below:

TABLE 1
Response Data

| | |
|---|---|
| Request To | IT |
| Category | Email Related Issue |
| Sub-Category | Login Issue |
| Details about the Issue | |
| Ticket Type | |
| Software Version | XYZ |
| Employee ID | XXX123 |

Thereafter, the system 202 is configured to identify the set of queries 204C from the plurality of queries 204B based on the received response data 204A. In an embodiment, the system 202 is configured to identify the set of queries 204C whose responses in the response data 204A are either absent or inaccurate. For the queries whose responses are absent, the system 202 is configured to determine a “null value” in response to the query. In an alternate embodiment, the system 202 is configured to apply the second ML model 210B to identify the set of queries 204C, whose responses in the response data 204A, are absent. Further, the system 202 is configured to apply the third ML model 210C to identify the set of queries 204C, whose responses in the response data 204A, are inaccurate. Inaccurate responses are the responses that do not correctly address the corresponding queries. In an embodiment, a response is considered inaccurate if it falls outside the threshold range from the established ground truth. For instance, in the context of information technology, consider the query: “What is the software version of application XYZ?”. If the response provided is “XYZ”, this is considered inaccurate because it refers to the name of the application rather than the required version number. The expected response should be a numerical value representing the software version, rather than a character string. Then the system 202 may identify this response as an inaccurate response and include this query in the identified set of queries.

By way of example, and not by limitation, the system 202 identifies the set of queries from the plurality of queries based on response data provided in Table 1. Since the responses to the two queries “Details about the Issue” and “Ticket Type” were absent, the system 202 includes the two queries in the identified set of queries. Further, the system 202 identifies that the response to the query “Software Version” was inaccurate in Table 1 (the response should've been in numerical such as 1.0, 2.0, or the like instead of characters). The identified set of queries is given in Table 2 below:

TABLE 2
Identified Set of queries

| | |
|---|---|
| 1. | Details about the Issue |
| 2. | Ticket Type |
| 3. | Software Version |

Further, the system 202 is configured to retrieve domain-specific data from the set of knowledge bases 208 associated with the specific domain. The system 202 is configured to retrieve the domain-specific data from the set of knowledge bases 208 based on the identification of the set of queries 204C. In an embodiment, the domain-specific data correspond to data tailored to a particular field, an industry, or an area of expertise, making the domain-specific data highly relevant and applicable for specific tasks, analyses, or decision-making processes within that particular domain. The domain-specific data is characterized by its specificity, and contextual relevance, which is obtained through research and operational activities within the specific domain.

By way of example, and not by limitation, the system 202 retrieves the domain-specific data associated with the IT domain. The domain-specific data associated with the IT domain may include data that may be critical for managing technology systems and troubleshooting issues. The domain-specific data may include user account information, such as various usernames and permissions; system logs that capture events and activities within the IT infrastructure; network configuration data detailing the setup of routers and switches; incident and change management records tracking reported issues and resolutions; and software inventory data that lists installed applications and compliance status. For example, the IT department may have a database that includes user account details, system logs, network configurations for troubleshooting connectivity, and records of software installations.

Thereafter, the system 202 is configured to generate the set of responses 204D for the identified set of queries 204C based on the retrieved domain-specific data. The set of responses 204D includes the accurate responses to the identified set of queries 204C (whose responses are either absent in the response data or are inaccurate). In an embodiment, the system 202 is configured to first correlate the information from the domain-specific data with the identified set of queries (whose responses are either absent or inaccurate) and further generate the set of responses 204D for the identified set of queries 204C based on the correlation. The system 202 is configured to apply the fifth ML model 210E to correlate the domain-specific data to generate the set of responses 204D for the identified set of queries 204C. The system 202 operates in real-time to address issues within the specific domains, such as IT-related problems, by processing the response data 204A at a processing speed that is challenging for human mind to achieve. Processing the response data 204A would be time-consuming and cumbersome for humans and would need significant time and effort of the humans, highlighting the need of the system 202. Specifically, the system 202 is designed to analyze and complete the set of queries 204C (the incomplete and inaccurate queries) by generating the set of responses 204D within a millisecond, allowing for rapid identification of the underlying issues.

For example, based on the correlation of the domain-specific data with the identified set of queries, the system 202 determines that in case of login issues, the main issue is that the user is unauthorized, and is unable to send/receive emails. Further, the system 202 determines that the request is a service request. Further, the system 202 identifies that the version of the email application is “2.3.1”. By way of example, and not by limitation, the system generates the set of responses for the identified set of queries given in Table 3 below:

TABLE 3
Set of Responses

| Details about the Issue | Unable to Send/ Receive |
|---|---|
| | Emails, Unauthorized User |
| Ticket Type | Service Request |
| Software Version | 2.3.1 |

Further, the system 202 is configured to apply the first ML model 210A to the response data 204A, the set of responses 204D, and the plurality of queries 204B. The first ML model 210A analyzes the patterns and relationships between the data (response data 204A, the set of responses 204D, and the plurality of queries 204B). The first ML model 210A is further configured to predict the set of solutions to resolve the issue based on the analysis.

Thereafter, the system 202 is configured to generate the set of solutions 214 to resolve the issue based on the application of the first ML model 210A to the response data 204A, the set of responses 204D, and the plurality of queries 204B. Each solution of the set of solutions 214 includes a series of operations that need to be executed to resolve the issue. By way of example, and not by limitation, the system 202 generates the set of solutions 214 to resolve the email login issue, the set of solutions 214 is given in Table 4 below:

TABLE 4
Set of Solutions

| | |
|---|---|
| 1. | Verify the user's role and permissions. |
| 2. | Update the user's access rights in the database. |
| 3. | Confirm that the user can access the application. |

To this end, the system 202 is configured to control the execution of the at least first solution of the generated set of solutions 214. In an embodiment, the system 202 is configured to control the execution of the at least first solution of the generated set of solutions. In an alternate embodiment, the system 202 is configured to control the execution of the at least first solution of the generated set of solutions on a database of the specific organization, for which the system 202 is implemented as a value-added service. The system 202 controls the execution of the at least first solution to resolve the issue. For example, the system 202 updates the access rights of the user in the database of the specific organization to resolve the email login issue.

Generation and execution of the set of solutions that may be generated directly using the response data 204A may lead to the issue not getting resolved in the first iteration as responses present in the response data 204A were inaccurate and incomplete. This might lead to an increase in the processing time for the resolution of the issue as there can be multiple iterations for the generation and execution of the set of solutions and there might be a possibility that the issue may not get resolved even after the multiple iterations (in case the provided information is incomplete and inaccurate). By ensuring that the set of solutions are generated using the combination of response data 204A, the plurality of queries 204B and the generated set of responses 204D, the system 202 firstly ensures that the set of solutions generated by the disclosed system includes all the critical steps that are needed to resolve the issue. By ensuring that the set of solutions generated by the disclosed system includes all the critical steps for the resolution of the issue, the system 202 further ensures that by controlling the execution of at least a first solution of the generated set of solutions resolves the issue in the first iteration. Since the system 202 eliminates the need for the generation and execution of the set of solutions in the multiple iterations, hence the disclosed system reduces the processing time for the resolution of the issue by ensuring that the at least first solution of the generated set of solutions resolves the issue in the first iteration. As discussed above, the system 202 further ensures that the execution of the at least first solution of generated set of solutions 214 resolves the issue in the first iteration, which leads to the issue getting resolved within a time frame, which is challenging for the human mind to achieve. Resolving the issue in the first iteration would be time-consuming and cumbersome for the humans and would need significant time and effort of the humans, highlighting the need of the system 202.

The system 202 operates in real-time to address issues within the specific domains, such as IT-related problems, by processing the response data 204A at a processing speed that is challenging for the human mind. Specifically, the system 202 is designed to analyze and complete the set of queries 204C (the incomplete and inaccurate queries) by generating the set of responses 204D within a millisecond, allowing for rapid identification of the underlying issues. This real-time processing by the system 202 is critical, as it enables the system 202 to generate the set of solutions 214 and execute the at least first solution of the set of solutions 214 almost instantaneously, which would be challenging for a human to perform. Generating the set of solutions would be time-consuming and cumbersome for the humans and would need significant time and effort of the humans, highlighting the need of the system 202.

Moreover, the system 202 not only generates the set of solutions 214 but also autonomously controls the execution of the at least first solution of the generated set of solutions 214. As discussed above, the system 202 further ensures that the execution of the at least first solution of generated set of solutions 214 resolves the issue in the first iteration, which leads to the issue getting resolved within a time frame, which is challenging for the human mind to achieve. Resolving the issue in the first iteration would be time-consuming and cumbersome for humans and would need significant time and effort of the humans, highlighting the need of the system 202. For instance, while humans might take several hours or even a day to gather information, analyze it, and propose a solution, the system 202 performs the execution of the at least first solution and resolves the issue within the time frame that is challenging for the human mind to achieve.

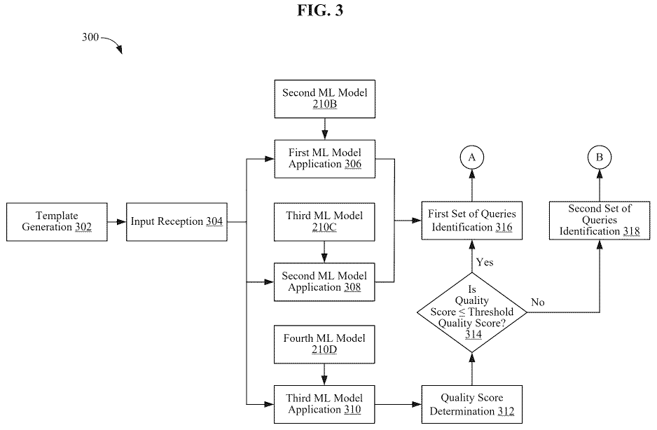

FIG. 3 is a diagram that illustrates exemplary operations for the identification of queries for the resolution of domain-specific issues, in accordance with an embodiment of the disclosure. FIG. 3 is explained in conjunction with elements from FIG. 1 and FIG. 2. With reference to FIG. 3, there is shown a block diagram 300 that illustrates exemplary operations from 302 to 318, as described herein. The exemplary operations illustrated in the block diagram 300 start at 302 and are performed by any computing system, apparatus, or device, such as by the computer 102 of FIG. 1 or by the computer system 202 of FIG. 2. With reference to FIG. 3, there is further shown the second ML model 210B, the third ML model 210C, and the fourth ML model 210D. Although illustrated with discrete blocks, the exemplary operations associated with one or more blocks of the block diagram 300 can be divided into additional blocks, combined into fewer blocks, or eliminated, depending on the implementation.

At 302, the template generation operation is performed. In the template generation operation, the system 202 is configured to generate the template for the reception of the response data 204A. The user may face an issue while working in a specific domain, for which the user provides an input, for example, the user may click on a helpdesk page of an organization's website. In an embodiment, the system 202 is configured to generate the template to receive the response data 204A based on the input. In an embodiment, in case the issue is detected, the system 202 is configured to generate and render the template on the user device 204 for the reception of the response data 204A. The template includes the plurality of queries 204B, for which the responses need to be obtained from either the set of knowledge bases 208 or the user device 204 in order to resolve the issue. By way of example, and not by limitation, the system 202 renders the template on the user device 204, the template includes the plurality of queries such as “Request To”, “Category”, “Sub-category”, and the like. The template is given in Table 5 below:

TABLE 5
Template
Request To
Category
Sub-Category
Details about the Issue
Ticket Type
Turn Around Time
Employee ID

At 304, an input reception operation is performed. In the input reception operation, the system 202 is configured to receive the response data 204A for the plurality of queries 204B, from the user device 204. The response data 204A indicates the response of the user 216 to the plurality of queries present in the generated template. As discussed above, the response data 204A includes the one or more responses to the plurality of queries associated with the issue within the specific domain. By way of example and not by limitation, the system receives the response data 204A for an issue within the “Human Resource (HR) Domain”. The response data includes the one or more responses to the plurality of queries that were provided in the generated template. The response data includes a response “HR” for the query “Request To”, a response “Letters” for the query “Category”, and a response “Appraisal Letter” for the query “Sub-Category” in the generated template of Table 5. The response data can be represented in Table 6 below:

TABLE 6
Response Data

| | |
|---|---|
| Request To | HR |
| Category | Letters |
| Sub-Category | Appraisal Letter |
| Details about the Issue | |
| Ticket Type | 1234 |
| Turn Around Time | |
| Employee ID | |

At 306, a first ML model application operation is performed. In the first ML model application operation, the system 202 is configured to apply the second ML model 210B to the received response data 204A. As discussed above, the second ML model 210B is a language model that is configured to identify a first set of queries (identified set of queries) from the plurality of queries. As discussed above, the responses to the first set of queries (identified set of queries), in the response data 204A, may be absent. It may be noted that the identified set of queries (described in the description of FIG. 1) and the first set of queries are the same queries. For the queries whose responses are absent, the system 202 is configured to determine a “null value” in response to the query. By way of example, and not by limitation, the system 202 identifies the first set of queries as “Details about the issue, Turn Around Time, and Employee ID” from Table 6 whose responses are absent in the response data 204A.

At 308, a second ML model application operation is performed. In the second ML model application operation, the system 202 is configured to apply the third ML model 210C to the received response data 204A. As discussed above, the third ML model 210C is a language model that is configured to identify the first set of queries (the identified set of queries) from the plurality of queries 204B whose responses, in the response data, are inaccurate. The first set of queries may be identified from the plurality of queries 204B. As discussed above, the responses to the first set of queries, in the response data 204A, may be inaccurate. In an embodiment, a response is considered inaccurate if it falls outside the threshold range from the established ground truth. For instance, in the context of information technology, consider the query: “What is the software version of application XYZ?”. If the response provided is “XYZ”, this is considered inaccurate because it refers to the name of the application rather than the required version number. The expected response should be a numerical value representing the software version, rather than a character string. Then the system 202 may identify this response as an inaccurate response and include this query in the first set of queries. By way of example, and not by limitation, the system 202 identifies the query “Ticket Type” from Table 6 in the identified set of queries since the response to this query should have been in characters instead of numeric, hence the response “1234” does not correctly address the query “Ticket Type”.

At 310, a third ML model application operation is performed. In the third ML model application operation, the system 202 is configured to apply the fourth ML model 210D to each query of the plurality of queries 204B and the response data 204A. In an embodiment, the fourth ML model 210D is a language model that is configured to determine a quality score associated with each query of the plurality of queries 204B. The quality score of the response of each query of the plurality of queries refers to how well the response addresses the corresponding query, in terms of various factors such as correctness, clarity, and comprehensiveness. The quality score indicates the accuracy, relevance, and completeness of the response. For example, referring to Table 6, for the “HR issue”, the response to the query “Sub-category” is “Appraisal Letter”, which correctly addresses the query “Sub-category” since “Appraisal Letter” is actually a Sub-category of the category “Letters”. Hence, the fourth ML model assigns a quality score of 0.7 to the query “Sub-category” on a scale of 0-1.

At 312, a quality score determination operation is performed. In the quality score determination operation, the system 202 is configured to determine the quality score associated with each query of the plurality of queries 204B based on the application of the fourth ML model to each query of the plurality of queries and the response data 204A. The quality score of the response of each query of the first set of queries refers to how well the response addresses the corresponding query, in terms of various factors such as correctness, clarity, and comprehensiveness. The quality score indicates the accuracy, relevance, and completeness of the response. For the absent responses, the system 202 assigns a quality score of 0 to the corresponding query on a scale of 0-1, meanwhile, for the inaccurate responses, the system 202 assigns a quality score between 0-0.4 (on the scale of 0-1). For example, if the response has just misspelled words like “Adress” instead of “Address”, then the system 202 may assign a quality score of 0.4, but in case the response is given in numerical values which should've been in character values instead, then the system 202 may assign a quality score of 0.2.

By way of example, and not by limitation, referring to Table 6, for the query “Request To” the response data is “HR” which is actually a domain in which the issue could be raised, hence the system assigns the query “Request to” with a quality score of 0.9 on the scale of 0-1 (refer to Table 7). For the query “Details about the Issue” the response is absent, hence the system 202 assigns a quality score of 0 to the query “Details about the issue” on the scale of 0-1 since the response is absent. For the query “Ticket type” the response is inaccurate since the query contains a numeric value “1234” instead of a character value, so the system 202 assigns a quality score of 0.2 to the response “Ticket type” on the scale of 0-1. The quality score associated with each query of the plurality of queries is provided in Table 7:

TABLE 7
Quality Score

| | |
|---|---|
| Request To | 0.9 |
| Category | 0.75 |
| Sub-Category | 0.7 |
| Details about the Issue | 0 |
| Ticket Type | 0.2 |
| Turn Around Time | 0 |
| Employee ID | 0 |

At 314, it is determined that if the quality score associated with each query of the plurality of queries 204B is less than or equal to a threshold quality score. In an embodiment, the system 202 is configured to compare the quality score associated with each query of the plurality of queries 204B with the threshold quality score. The threshold quality score is a threshold score that the quality score of a response must have, in order to be considered satisfactory for a given query. Responses whose quality score is less than or equal to the threshold quality score may be considered inaccurate or unfit for the generation of solutions, while those responses whose quality score are greater than the threshold quality score are considered accurate and fit for the generation of solutions. Details about the generation of solutions are provided, for example, in FIG. 4. For example, the threshold quality score maybe 0.5 on a scale of 0-1.

In case the system 202 determines that the quality score is less than or equal to the threshold quality score, the control of operations proceeds to 316 to identify the first set of queries whose responses, in the response data, are either absent or inaccurate so that the system 202 can generate correct responses (the set of responses 204D) for the first set of queries. In case the system 202 determines that the quality score associated with each query of the plurality of queries is greater than the threshold quality score, the control of operations proceeds to 318 to identify the second set of queries whose responses, in the response data, are present and are accurate as well. The system 202 can directly generate the solutions for the second set of queries since the responses for the second set of queries are already present and are accurate. Details about the generation of solutions are provided, for example, in FIG. 4.

At 316, a first set of queries identification operation is performed. In the first set of queries determination operation, the system 202 is configured to identify the first set of queries from the plurality of queries based on the quality score. In an embodiment, the system 202 is configured to identify the first set of queries from the plurality of queries 204B based on the determination that the quality score associated with each query of the plurality of queries is less than or equal to the threshold quality score. In an alternate embodiment, the system 202 is configured to identify the first set of queries from the plurality of queries 204B based on the application of the second ML model 210B to the received response data 204A. In an alternate embodiment, the system 202 is configured to identify the first set of queries from the plurality of queries 204B based on the application of the second ML model 210B to the received response data 204A. The first set of queries includes the one or more queries from the plurality of queries, whose responses in the received response data 204A, are either absent or inaccurate. The first set of queries further includes the one or more queries from the plurality of queries, whose quality score is less than or equal to the threshold quality score.

The first set of queries further indicates the one or more queries for which the system 202 generates the set of responses 204D in order to generate the set of solutions to resolve the query since the quality score is less than or equal to the threshold quality score. Details about the generation of the set of responses and the set of solutions are provided, for example, in FIG. 4. By way of example, and not by limitation, referring to Table 6, for the queries “Details about the Issue”, “Turn Around Time”, and “Employee ID”, the responses were absent, and for the query “Ticket Type”, the response is inaccurate since the response contains numerical values instead of character values. Also, referring to Table 7, the quality score of each of the queries “Details about the Issue”, “Turn Around Time”, “Ticket Type, and “Employee ID” is less than the threshold quality score (0.5). So the system 202 includes each of the queries “Details about the Issue”, “Turn Around Time”, “Ticket Type, and “Employee ID” in the first set of queries. The first set of queries are provided in Table 8 below:

TABLE 8
First Set of queries

| | |
|---|---|
| 1. | Details about the Issue |
| 2. | Ticket Type |
| 3. | Turn Around Time |
| 4. | Employee ID |

At 318, a second set of queries identification operation is performed. In the second set of queries identification operation, the system 202 is configured to identify a second set of queries from the plurality of queries 204B based on the determination that the quality score associated with each query of the plurality of queries is greater than the threshold quality score. The second set of queries includes the one or more queries from the plurality of queries, whose responses, in the response data, are complete and accurate. The second set of queries further includes the one or more queries from the plurality of queries, whose quality score is greater than the threshold quality score.

The second set of queries further indicates the one or more queries for which the system 202 need not generate the set of responses 204D in order to generate the set of solutions to resolve the query since the quality score is already greater than the threshold quality score. Details about the generation of the set of solutions are provided, for example, in FIG. 4. By way of example, and not by limitation, referring to Table 6, for the queries “Category” and “Sub-category”, the responses are accurately present. Further, referring to Table 7, the quality score of each of the queries “Category”, and “Sub-category” is greater than the threshold quality score (0.5). The second set of queries are provided in Table 9 below:

TABLE 9
Second Set of queries

| | |
|---|---|
| 1. | Request To |
| 2. | Category |
| 3. | Sub-category |

The system may be further configured to generate the set of solutions to resolve the issue based on the identified first set of queries and the identified second set of queries. As discussed above, for the identified first set of queries, the system 202 generates the set of responses 204D and then generates the set of solutions since the responses for the identified first set of queries, in the response data, were absent or inaccurate. Meanwhile for the identified second set of queries, the system 202 directly generates the set of solutions, since the responses for the identified second set of queries, in the response data, were present and accurate. Details about the generation of the set of solutions and the set of responses are provided, for example, in FIG. 4.

FIG. 4 is a diagram that illustrates exemplary operations for the generation of solutions for the resolution of domain-specific issues, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402 to 418, as described herein. The exemplary operations illustrated in the block diagram 400 start at 420, and are performed by any computing system, apparatus, or device, such as by the computer 102 of FIG. 1 or by the computer system 202 of FIG. 2. With reference to FIG. 4, there is further shown the first ML model 210A and the fifth ML model 210E. Although illustrated with discrete blocks, the exemplary operations associated with one or more blocks of the block diagram 400 can be divided into additional blocks, combined into fewer blocks, or eliminated, depending on the implementation.

At 402, a domain identification operation is performed. In the domain identification operation, the system 202 is configured to identify the specific domain associated with the issue. In an embodiment, the system 202 is configured to apply a language model (e.g. the fifth ML model 210E) to the received response data 204A to identify the specific domain in which the user may be facing the issue. By way of example, referring to Table 6, the system 202 identifies that the specific domain of the issue is “Human Resources (HR)”.

At 404, a domain-specific data retrieval operation is performed. In the domain-specific data retrieval operation, the system 202 is configured to retrieve the domain-specific data associated with the identified specific domain from the set of knowledge bases 208 associated with the specific domain. In an embodiment, the domain-specific data corresponds to data that is tailored to a particular field, industry, or area of expertise, making the data highly relevant and applicable for specific tasks, analyses, or decision-making processes within that domain. The domain-specific data is characterized by its specificity, depth, and contextual relevance, which is obtained through research and operational activities within the specific domain.

By way of example, and not by limitation, since the specific domain of the issue is “HR”, the system 202 retrieves the domain-specific data associated with the HR domain. The domain-specific data associated with the HR domain may include various types of data critical for managing employee relations, recruitment, and organizational development. The domain-specific data includes employee records containing information, job titles, and performance evaluations; recruitment data that tracks job postings, applicant resumes, and interview feedback; payroll information detailing salary structures, bonuses, and deductions; training and development records that document employee training programs and certifications; and compliance data related to labor laws and regulations. For example, an HR department of the specific organization may maintain a database that includes employee profiles with performance reviews, recruitment metrics, training records, and the like.

At 406, a first subset of queries identification operation is performed. In the first subset of queries identification operation, the system 202 is configured to identify a first subset of queries from the first set of queries (the identified set of queries 204C) based on the retrieved domain-specific data. The first subset of queries includes the queries whose responses can be generated based on the domain-specific data since the domain-specific data includes the data associated with the first subset of queries. In an embodiment, the first subset of queries includes the one or more queries from the first set of queries, whose responses can be generated by correlating the retrieved domain-specific data with the one or more queries. The system 202 analyzes the retrieved domain-specific data (using the language model such as the fifth ML model) and identifies the first subset of queries based on the analysis.

By way of example, and not by limitation, referring to Table 8 (from the first set of queries), the system 202 identifies that responses to the queries “Details about the issues” and “Ticket type” can be generated by the system 202 based on the domain-specific data since the domain-specific data includes the details about the issue of “Appraisal Letter”, details about “Ticket Type”, and details about the “Turn Around Time”. Hence, the system 202 includes the queries “Details about the issues” and “Ticket type” in the first subset of queries. The first subset of queries are provided in Table 10 below:

TABLE 10
First Subset of Queries

| | |
|---|---|
| 1. | Details about the Issue |
| 2. | Ticket Type |
| 3. | Turn Around Time |

At 408, a fourth ML model application operation is performed. In the fourth ML model application operation, the system 202 is configured to apply the fifth ML model 210E to the first subset of queries and the domain-specific data. The fifth ML model 210E is configured to analyze the first subset of queries and the domain-specific data and then correlate each query of the first subset of queries with the domain-specific data. In an embodiment, the fifth ML model is configured to match keywords from each query of the first subset of queries with specific entries in the domain-specific data to correlate the first subset of queries with the domain-specific data. For example, the system 202 correlates the query “Details about the issue” with the data from the domain-specific data, associated with the “Appraisal letters”. Similarly, the system 202 correlates various queries from the first subset of queries with the domain-specific data.

At 410, a query correlation operation is performed. In the query correlation operation, the system 202 is configured to correlate each query of the first subset of queries with the domain-specific data based on the application of the fifth ML model to the first subset of queries and the domain-specific data. In an embodiment, the system 202 is configured to correlate each query of the first subset of queries with the domain-specific data to generate a response for the corresponding query of the first subset of queries. By way of example, and not by limitation, the system 202 correlates the first subset of queries with the information stored in the database maintained by the HR department of the specific organization. For example, the system 202 correlates the query “Details about the issue” with the data from the domain-specific data, associated with the “Appraisal letters”.

At 412, a second subset of queries identification operation is performed. In the second subset of queries identification operation, the system 202 is configured to identify a second subset of queries from the first set of queries (the identified set of queries 204C) based on the retrieved domain-specific data. The second subset of queries includes the queries whose responses can only be generated using feedback data from the user device 204 since the domain-specific data does not include the data associated with the second set of queries. In an embodiment, the second subset of queries includes the one or more queries from the first set of queries, whose responses can be generated by the system 202 by receiving feedback from the user device 204 and not only by correlating the domain-specific data. By way of example, and not by limitation, the system 202 identifies the “Employee ID” query as the second subset of queries since the system 202 cannot determine the Employee ID of the employee just by correlating the query with the domain-specific data.

At 414, a feedback reception operation is performed. In the feedback reception operation, the system 202 is configured to receive feedback data associated with the second subset of queries from the user device 204. In an embodiment, the system 202 is configured to receive the feedback data since the responses to the second subset of queries cannot be generated by correlating the domain-specific data with the second subset of queries. The feedback data includes the feedback (or a response) of the user 216 to the second subset of queries. By way of example, and not by limitation, the system 202 receives the feedback data to the “Employee ID” as “XYZ1234”. The system 202 identifies the “Employee ID” of the user as “XYZ1234”.

At 416, a response generation operation is performed. In the response generation operation, the system 202 is configured to generate the set of responses to the first set of queries (identified set of queries 204C) based on the feedback data and the correlation of the first subset of queries with the domain-specific queries. In an embodiment, the system 202 is configured to generate a first subset of responses to the first subset of queries based on the correlation of the first subset of queries with the domain-specific data The system 202 is further configured to generate a second subset of responses to the second subset of queries based on the received feedback data. In an embodiment, the system 202 is further configured to generate the set of responses to the first set of queries based on a combination of the first subset of responses and the second subset of responses. The set of responses includes the first subset of responses and the second subset of responses.

By way of example, and not by limitation, the system 202 generates the set of responses to the first subset of queries. Referring to Table 8, the system 202 generates the responses to the “Details about the issue” as “Haven't yet received my appraisal letter” since this was the most common issue among the issues related to “Appraisal letters” in the domain-specific data. The system 202 further generates a response to the “Ticket Type” as “Service Request” and the response to “Turn Around Time” as “1 Day” since the type of this issue (available in domain-specific data) associated with “Appraisal Letter” is a service request and the Turn Around Time is 1 day as per the domain-specific data. The system 202 further generates the response to “Employee ID” as “XYZ1234” based on the feedback. The set of responses is provided in Table 11 below:

TABLE 11
Set of Responses

| | |
|---|---|
| Details about the Issue | Haven't yet received my appraisal letter |
| Ticket Type | Service Request |
| Turn Around Time | 1 Day |
| Employee ID | XYZ1234 |

At 418, a fifth ML model application operation is performed. In the fifth ML model application operation, the system 202 is configured to apply the first ML model 210A to the set of responses 204D, the response data 204A, and the plurality of queries 204B. In an embodiment, the first ML model 210A is configured to predict the set of solutions to resolve the issue, the prediction is based on the set of responses 204D, the response data 204A, and the plurality of queries 204B. The first ML model 210A analyzes the patterns and relationships between the data (response data 204A, the set of responses 204D, and the plurality of queries 204B) and the training dataset. The first ML model 210A is further configured to predict the set of solutions to resolve the issue based on the analysis.

At 420, a solution generation operation is performed. In the solution generation operation, the system 202 is configured to generate the set of solutions based on the application of the first ML model 210A to the set of responses 204D, the response data 204A, and the plurality of queries 204B. In an embodiment, each solution of the set of solutions 214 includes a series of operations that need to be executed to resolve the issue. By way of example, and not by limitation, the system 202 generates the set of solutions 214 to resolve the Appraisal letter issue, the first solution includes three operations (1. Obtain performance data of the user 2. Check if the user qualifies for appraisal based on performance data 3. Send the appraisal letter to the user if the user qualifies) and the second solution includes three operations (1. Send a message to the HR team to check if the user qualifies for appraisal 2. Receive the input from the HR team 3. Send the appraisal letter to the user in case the input indicates approval for the transmission of the appraisal letter). The first solution and the second solution of the set of solutions 214 are given in Table 12 and Table 13 below:

TABLE 12
First Solution of the Set of Solutions

| | |
|---|---|
| 1. | Obtain the performance data of the user. |
| 2. | Check whether the user qualifies for appraisal |
| | based on the performance data. |
| 3. | Send the appraisal letter to the user if the user qualifies. |

TABLE 13
Second Solution of the Set of Solutions

| | |
|---|---|
| 1. | Send a message to the HR team to check if the |
| | user qualifies for an appraisal |
| 2. | Receive the input from the HR team. |
| 3. | Send the appraisal letter to the user in case the |
| | input indicates an approval for |
| | the transmission of the appraisal letter. |

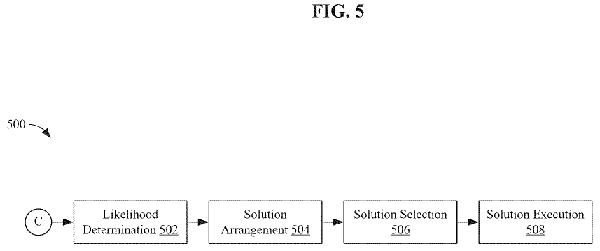

FIG. 5 is a diagram that illustrates exemplary operations for the execution of solutions for the resolution of domain-specific issues, in accordance with an embodiment of the disclosure. FIG. 5 is explained in conjunction with elements from FIG. 1, FIG. 2, FIG. 3 and FIG. 4. With reference to FIG. 5, there is shown a block diagram 500 that illustrates exemplary operations from 502 to 508, as described herein. The exemplary operations illustrated in the block diagram 500 start at 502, and are performed by any computing system, apparatus, or device, such as by the computer 102 of FIG. 1 or by the computer system 202 of FIG. 2. Although illustrated with discrete blocks, the exemplary operations associated with one or more blocks of the block diagram 500 can be divided into additional blocks, combined into fewer blocks, or eliminated, depending on the implementation.

At 502, a likelihood determination operation is performed. In the likelihood determination operation, the system 202 is configured to determine a set of likelihood values associated with the set of solutions. In an embodiment, each likelihood value of the set of likelihood values is indicative of a likelihood of a corresponding solution of the set of solutions 214 to resolve the issue. The likelihood of a specific solution to resolve the issue refers to the chance that the specific solution will successfully address and fix the issue. The likelihood of the specific solution indicates the feasibility and effectiveness of the specific solution to resolve the issue. In an embodiment, the system 202 is configured to determine the likelihood value of the corresponding solution to resolve the issue, based on an application of the language model (e.g. the fifth ML model 210E) to the set of solutions and the issue. By way of example, and not by limitation, referring to Table 12 and Table 13, the system 202 determines that the first solution has a greater likelihood to resolve the issue as compared to the second solution because in the case of the second solution, there is an operation (2. Receive the input from the HR team), which can cause delays to the transmission of the appraisal letter in case there are delays from the end of the HR team in sending the input. Meanwhile, the first solution doesn't involve any such operations that might lead to delays. Hence, the first solution has a greater likelihood to resolve the issue as compared to the second solution. At 504, a solution arrangement operation is performed. In the solution arrangement operation, the system 202 is configured to arrange the generated set of solutions 214 based on the determined set of likelihood values. In an embodiment, the system 202 is configured to arrange the generated set of solutions 214 in descending order based on the determined set of likelihood values (the solution having the greatest likelihood to resolve the issue in the set of solutions will be arranged at the forefront). For example, as discussed above, since the first solution has a greater likelihood to resolve the issue than the second solution, the system 202 arranges the first solution above the second solution (descending order).

At 506, a solution selection operation is performed. In the solution selection operation, the system 202 is configured to select the at least first solution of the generated set of solution 214 based on the arrangement of the generated set of solutions. In an embodiment, the system 202 is configured to select the at least first solution from the generated set of solutions 214, the selected first solution has the maximum likelihood, among the generated set of solutions 214, to resolve the issue. For example, the system 202 selects the first solution (described in Table 12) to resolve the issue.

At 508, a solution execution operation is performed. In the solution execution operation, the system 202 is configured to control the execution of at least the selected first solution of the generated set of solutions 214. In an embodiment, the system 202 is configured to control the execution of the at least selected first solution of the generated set of solutions on the database of the specific organization, for which the system 202 is implemented as a value-added service. The system 202 controls the execution of the at least selected first solution to resolve the issue. For example, the system 202 executes the first solution (given in Table 12) and sends the appraisal letter to the user if the user qualifies.

Generation and execution of the set of solutions that may be generated directly using the response data 204A may lead to the issue not getting resolved in the first iteration as responses present in the response data 204A were inaccurate and incomplete. This might lead to an increase in the processing time for the resolution of the issue as there can be multiple iterations for the generation and execution of the set of solutions and there might be a possibility that the issue may not get resolved even after the multiple iterations (in case the provided information is incomplete and inaccurate). By ensuring that the set of solutions are generated using the combination of response data 204A, the plurality of queries 204B and the generated set of responses 204D, the system 202 firstly ensures that the set of solutions generated by the disclosed system includes all the critical steps that are needed to resolve the issue. By ensuring that the set of solutions generated by the disclosed system includes all the critical steps for the resolution of the issue, the system 202 further ensures that by controlling the execution of at least a first solution of the generated set of solutions resolves the issue in the first iteration. Since the system 202 eliminates the need for the generation and execution of the set of solutions in the multiple iterations, hence the disclosed system reduces the processing time for the resolution of the issue by ensuring that the at least first solution of the generated set of solutions resolves the issue in the first iteration.

FIG. 6 is a diagram that illustrates the training of a machine learning (ML) model for the resolution of domain-specific issues, in accordance with an embodiment of the disclosure. FIG. 6 is explained in conjunction with FIG. 1, FIG. 2, FIG. 3, FIG. 4, and FIG. 5. As shown, there is a training portion above line 600 and an implementation portion below line 600. With reference to FIG. 6, there is further shown the first ML model 210A. In the training portion above line 600, the computer system 202 retrieves historical data from the one or more data sources 206 to generate a training dataset for training 602 of the first ML model 210A based on the training dataset.

At 604, a historical data retrieval operation is performed. In the historical data retrieval operation, the system 202 is configured to retrieve historical data from the one or more data sources 206. In an embodiment, the historical data includes a plurality of historical issues and a plurality of historical solutions associated with the plurality of historical issues. Each historical solution of the plurality of historical solutions is associated with a resolution of a corresponding issue of the plurality of historical issues. The plurality of historical issues may be associated with a plurality of domains. The historical data further includes the plurality of historical issues faced by the employees of the specific organization for which the system 202 is implemented as a value-added service. The historical data further includes the plurality of historical issues faced by the employees of the same industry as the specific organization for which the system 202 is implemented as a value-added service. The historical data may further include seasonal data that may include seasonal issues faced by the users. For example, during client visits, organizations may face IT issues more frequently as compared to normal days, then the historical data may include the issues faced by users during these client visits. The historical data may be obtained from the one or more data sources 206 for example, social networks, news sources, IOT tools, and the like. By way of example, and not by limitation, one or more users may have faced the plurality of historical issues within the plurality of domains and have resolved via the plurality of historical solutions. The users may have faced issues within domains such as “HR”, “IT”, “Accounts”, and the like. The system 202 obtains the plurality of historical issues associated with each of the domains. The system 202 further obtains the plurality of historical solutions that the users may have implemented to resolve the issue.

At 606, a training dataset generation operation is performed. In the training dataset generation operation, the system 202 is configured to generate the training dataset based on the retrieved historical data to train the first ML model 210A. In an embodiment, the training dataset includes the plurality of historical issues as a set of input values and the plurality of solutions as the set of output values. The system 202 generates the training data for the training 602 of the ML model. By way of example, and not by limitation, the system 202 generates the training dataset for the training 602 of the first ML model 210A, the training dataset includes the plurality of historical issues associated with the plurality of domains such as “HR”, “IT”, “Accounts”, or the like and the plurality of historical solutions. The training dataset is provided in Table 14 below:

TABLE 14
Training Dataset

| Set of input values | Set of output values |
|---|---|
| HR-related | 1. Obtain the user's records. |
| Documentation | 2. Determine the documents that |
| Issue | need to be issued. |
| | 3. Send the documents to the user. |
| Application | 1. Verify the user's role and |
| Login Issue | permissions. |
| | 2. Update the user's access rights in |
| | the database. |
| | 3. Confirm that the user can access |
| | the application. |
| Accounts Issue | 1. Obtain the user's details |
| | 2. Check for the income or |
| | benefits that the user qualifies |
| | 3. Disburse the income or the |
| | benefits if the user qualifies |
| Admin-related issue | 1. Analyse the issue |
| | 2. Check if the issue needs manual |
| | intervention (e.g., in case the air |
| | conditioner is not working |
| | perfectly) |
| | 3. If the issue can be solved |
| | automatically, then obtain |
| | instructions to resolve the issue |
| | (e.g., identity card lost) |
| | 4. Transmit the issue to an expert if |
| | the issue needs manual |
| | interventions otherwise execute |
| | instructions to resolve the issue. |

At 608, a first ML model training operation is performed. In the first ML model training operation, the system 202 is configured to train the first ML model 210A based on the training dataset. In an embodiment, the system 202 is configured to provide the first ML model 210A with the set of input values (the plurality of historical issues). The first ML model 210A determines a machine learning (ML) algorithm for the determination of the set of output values (the plurality of historical solutions) based on the set of output values (the plurality of historical solutions).

In an embodiment, the system 202 is further configured to adjust the weights and the hyperparameters of the first ML model 210A based on a determination that a predicted output value (a predicted solution) is not equal to (or does not match) the actual output value (the actual solution) in the set of output values. In an embodiment, the system 202 is further configured to repeat the adjustment of the weights and the hyperparameters until the predicted output matches the actual output for various input-output pairs in the training dataset, or until the minima of the loss function is achieved or the training error is minimized.

In the implementation portion below line 600, input data 610 for the application of the first ML model 210A is generated. In an embodiment, the input data includes the plurality of queries 204B, the response data 204A, and the generated set of responses 204D. In an embodiment, the system 202 is configured to generate the input data 610 based on the plurality of queries 204B, the response data 204A, and the generated set of responses 204D. Details about the generation of the set of responses are provided, for example, in FIG. 4. By way of example, and not by limitation, the system 202 generates the input data 610 for the application of the first ML model 210A, the input data 610 is provided in Table 15 below:

TABLE 15
Input Data

| | |
|---|---|
| Request To | Accounts |
| Category | Salary |
| Sub-Category | Bonus |
| Details about the Issue | Haven't received the bonus yet |
| Ticket Type | Service Request |
| Turn Around Time | 1 day |
| Employee ID | ABC3334 |

At 612, a first ML model application operation is performed. In the first ML model application operation, the system 202 is configured to apply the first ML model 210A to the input data 610. In an embodiment, the first ML model 210A is configured to predict the set of solutions to resolve the issue, the prediction is based on the set of responses 204D, the response data 204A, and the plurality of queries 204B. The first ML model 210A analyzes the patterns and relationships between the input data 610 (response data 204A, the set of responses 204D, and the plurality of queries 204B) and its training dataset. The first ML model 210A is further configured to predict the set of solutions to resolve the issue based on the analysis.

At 614, a solution generation operation is performed. In the solution generation operation, the system 202 is configured to generate the set of solutions based on the application of the first ML model 210A to the input data 610 (the set of responses 204D, the response data 204A, and the plurality of queries 204B). In an embodiment, each solution of the set of solutions 214 includes a series of operations that need to be executed to resolve the issue. By way of example, and not by limitation, the system 202 generates the set of solutions 214 to resolve the Bonus issue, the set of solutions 214 is given in Table 16 below:

TABLE 16
Set of Solutions

| | |
|---|---|
| 1. | Obtain the user's details. |
| 2. | Check if the user qualifies for a bonus. |
| 3. | Disburse the bonus amount if the user qualifies. |

At 616, a solution output operation is performed. In the solution output operation, the system 202 is configured to control the execution of the at least first solution of the generated set of solutions 214 to resolve the issue. In an alternate embodiment, the system 202 is configured to control the execution of the at least first solution of the generated set of solutions on a database of the specific organization, for which the system 202 is implemented as a value-added service. The system 202 controls the execution of the at least first solution to resolve the issue. Details about the execution of the at least first solution of the set of solutions are provided, for example, in FIG. 5. For example, the system 202 executes the set of solutions (provided in Table 16) to disburse the bonus amount to the user to resolve the issue.

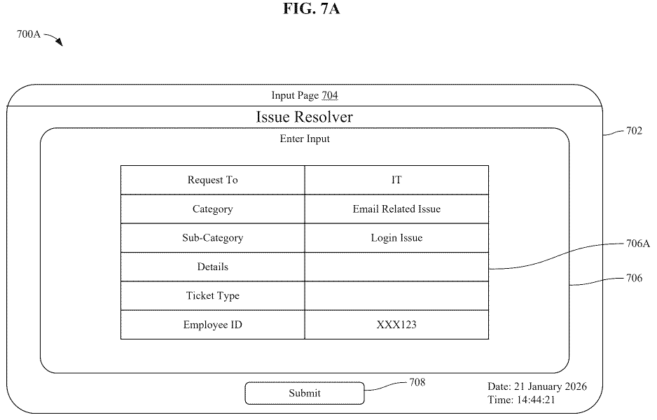

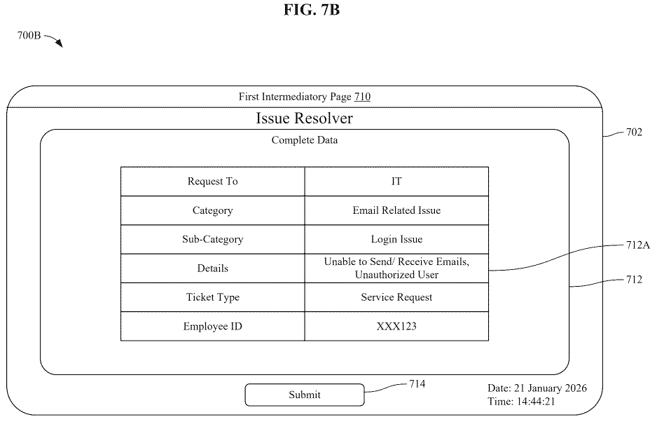

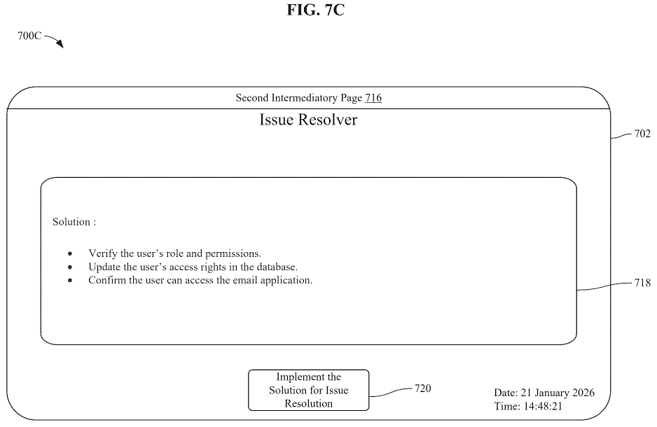

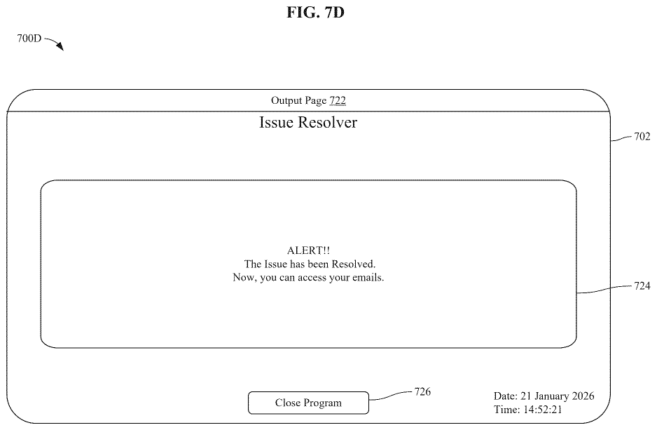

FIG. 7A is a diagram that illustrates an exemplary first user interface for the resolution of domain-specific issues, in accordance with an embodiment of the disclosure. FIG. 7A is explained in conjunction with elements from FIG. 1, FIG. 2, FIG. 3, FIG. 4, FIG. 5, and FIG. 6. With reference to FIG. 7A, there is shown an exemplary diagram 700A that includes a user device 702 and an input page 704. The input page 704 includes a first user interface (UI) element 706, a second UI element 706A, and a third UI element 708. The user device 702 is an exemplary embodiment of the user device 204 of FIG. 2.

With reference to FIG. 7A, the computer system 202 renders the input page 704 on the user interface (UI) of the user device 702. The input page 704 corresponds to a web page or online form that is designed to collect response data 204A from an entity or the user 216 who faces any issue within the specific domain. In an embodiment of the disclosure, the input page 704 is used to gather relevant details from the user 216 to resolve the issue.

The first UI element 706 corresponds to a textbox labeled “Enter Input”. The first UI element 706 is used to obtain the response data 204A from the user 216. The first UI element 706 further includes the second UI element 706A. The second UI element 706A corresponds to a table of textboxes. The second UI element 706A is used to obtain responses to the plurality of queries 204B. The third UI element 708 corresponds to a button labeled “Submit”. Upon selecting the third UI element 708, the system 202 is configured to initiate the process of resolution of domain-specific issues. Details about the resolution of domain-specific issues are provided in FIG. 2, FIG. 3, and FIG. 4.

FIG. 7B is a diagram that illustrates an exemplary second user interface for the resolution of domain-specific issues, in accordance with an embodiment of the disclosure. FIG. 7B is explained in conjunction with elements from FIG. 1, FIG. 2, FIG. 3, FIG. 4, FIG. 5, FIG. 6, and FIG. 7A. With reference to FIG. 7B, there is shown an exemplary diagram 700B that includes a user device 702 and a first intermediatory page 710. The first intermediatory page 710 includes a fourth user interface (UI) element 712, a fifth UI element 712A, and a sixth UI element 714. The user device 702 is an exemplary embodiment of the user device 204 of FIG. 2.

With reference to FIG. 7B, the computer system 202 renders the first intermediatory corresponds to a web page or online form that indicates the user 216 about the completion of the response data 204A based on the generated set of responses. In an embodiment of the disclosure, the system 202 is configured to complete the response data 204A based on correlation of the domain-specific data with the set of queries 204C, to resolve the issue. Details about the correlation of the domain-specific data with the set of queries 204C are provided in FIG. 4.

The fourth UI element 712 corresponds to a textbox labeled “Complete Data”. The fourth UI element 712 further includes the fifth UI element 712A. The fifth UI element 712A corresponds to a table that indicates the user about the completion of the response data 204A based on the generated set of responses. The sixth UI element 714 corresponds to a button labeled “Submit”. Upon selecting the sixth UI element 714, the system 202 is configured to generate the set of solutions 214 to resolve the issue. Details about the generation of the set of solutions 214 are provided in FIG. 2, and FIG. 4.

FIG. 7C is a diagram that illustrates an exemplary third user interface for the resolution of domain-specific issues, in accordance with an embodiment of the disclosure. FIG. 7C is explained in conjunction with elements from FIG. 1, FIG. 2, FIG. 3, FIG. 4, FIG. 5, FIG. 6, FIG. 7A and FIG. 7B. With reference to FIG. 7C, there is shown an exemplary diagram 700C that includes a user device 702 and a second intermediatory page 716. The second intermediatory page 716 includes a seventh user interface (UI) element 718, and an eighth UI element 720. The user device 702 is an exemplary embodiment of the user device 204 of FIG. 2.

With reference to FIG. 7C, the computer system 202 renders the second intermediatory page 716 on the user interface (UI) of the user device 702. The second intermediatory page 716 corresponds to a web page or online form that indicates the set of solutions 214 that needs to be implemented in order to resolve the issue.

The seventh UI element 718 corresponds to a textbox. For example, the textbox includes the message “Solution: Verify User's Role and permissions, Update the user's access rights in the database, Confirm the user can access the email application”. The seventh UI element 718 is used to indicate the set of solutions 214 that needs to be implemented in order to resolve the issue. The eighth UI element 720 corresponds to a button labeled “Implement the Solution for Issue Resolution”. Upon selecting the seventh UI element 718, the system 202 is configured to execute the set of solutions to resolve the issue. Details about the execution of the solutions are provided in FIG. 5.

FIG. 7D is a diagram that illustrates an exemplary fourth user interface for the resolution of domain-specific issues, in accordance with an embodiment of the disclosure. FIG. 7D is explained in conjunction with elements from FIG. 1, FIG. 2, FIG. 3, FIG. 4, FIG. 5, FIG. 6, FIG. 7A, FIGS. 7B and 7C. With reference to FIG. 7D, there is shown an exemplary diagram 700D that includes a user device 702 and an output page 722. The output page 722 includes a ninth user interface (UI) element 724, and a tenth UI element 726. The user device 702 is an exemplary embodiment of the user device 204 of FIG. 2.

With reference to FIG. 7D, the computer system 202 renders the output page 722 on the user interface (UI) of the user device 702. The output page 722 corresponds to a web page that indicates the user, the information about the resolution of the issue. The ninth UI element 724 corresponds to a textbox. For example, the textbox is labeled as “Alert!! The Issue has been Resolved. Now, you can access your emails.”. The tenth UI element 726 corresponds to a button labeled “Close Program” to terminate the process.

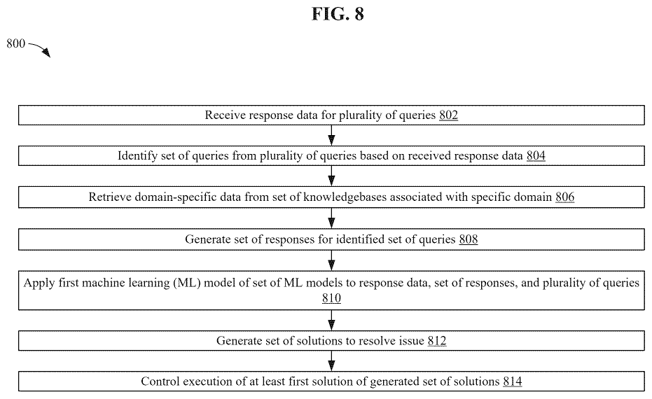

FIG. 8 is a diagram that illustrates a flowchart of an exemplary method for the resolution of domain-specific issues, in accordance with an embodiment of the disclosure. FIG. 8 is explained in conjunction with elements from FIG. 1, FIG. 2, FIG. 3, FIG. 4, FIG. 5, FIG. 6, FIG. 7A, FIG. 7B, FIG. 7C, and FIG. 7D. With reference to FIG. 8, there is shown a flowchart 800. The operations of the exemplary method may be executed by any computing system, for example, by the computer 102 of FIG. 1 or the computer system 202 of FIG. 2. The operations of the flowchart 800 may start at 802.

At 802, the response data 204A for the plurality of queries 204B is received. The plurality of queries 204B is associated with the issue in the specific domain. In an embodiment of the disclosure, the computer system 202 receives the response data 204A for the plurality of queries 204B. The plurality of queries 204B is associated with the issue in the specific domain. Details about the response data reception are provided, for example, in FIG. 2 and FIG. 3.

At 804, the set of queries 204C from the plurality of queries 204B is identified based on the received response data 204A. In an embodiment of the disclosure, the computer system 202 identifies the set of queries 204C from the plurality of queries 204B based on the received response data 204A. Details about the identification of the set of queries are provided, for example, in FIG. 2, and FIG. 3.

At 806, domain-specific data is retrieved from the set of knowledge bases 208 associated with the specific domain. The domain-specific data is retrieved based on the identification of the set of queries 204C. In an embodiment of the disclosure, the computer system 202 is configured to retrieve the domain-specific data from the set of knowledge bases 208 associated with the specific domain. The domain-specific data is retrieved based on the identification of the set of queries 204C. Details about the domain-specific data retrieval are provided, for example, in FIG. 2 and FIG. 4.

At 808, the set of responses 204D is generated for the identified set of queries. The set of responses 204D is generated based on the retrieved domain-specific data. In an embodiment of the disclosure, the computer system 202 is configured to generate the set of responses 204D for the identified set of queries. The set of responses 204D is generated based on the retrieved domain-specific data. Details about the set of response generation are provided, for example, in FIG. 2 and FIG. 4.

At 810, the first ML model 210A of the set of ML models 210 is applied to the response data 204A, the set of responses 204D, and the plurality of queries 204B. In an embodiment of the disclosure, the computer system 202 is configured to apply the first ML model 210A of the set of ML models 210 to the response data 204A, the set of responses 204D, and the plurality of queries 204B. Details about the first ML model application are provided, for example in FIG. 2 and FIG. 4.

At 812, the set of solutions 214 is generated to resolve the issue. The set of solutions 214 is generated based on the application of the first ML model 210A to the response data 204A, the set of responses 204D, and the plurality of queries 204B. In an embodiment of the disclosure, the computer system 202 is configured to generate the set of solutions 214 to resolve the issue. The set of solutions 214 is generated based on the application of the first ML model 210A to the response data 204A, the set of responses 204D, and the plurality of queries 204B. Details about the set of solutions generation are provided, for example, in FIG. 2 and FIG. 4.

At 814, the execution of at least the first solution of the generated set of solutions 214 is controlled. In an embodiment of the disclosure, the computer system 202 is configured to control the execution of at least the first solution of the generated set of solutions 214. Details about the execution of at least the first solution of the generated set of solutions 214 are provided, for example, in FIG. 2 and FIG. 5.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the embodiments described. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
receiving, by a computer, response data for a plurality of queries, wherein the plurality of queries is associated with an issue in a specific domain;
identifying, by the computer, a set of queries from the plurality of queries based on the received response data;
retrieving, by the computer, domain-specific data from a set of knowledge bases associated with the specific domain, wherein the domain-specific data is retrieved based on the identification of the set of queries;
generating, by the computer, a set of responses for the identified set of queries, wherein the set of responses is generated based on the retrieved domain-specific data;
applying, by the computer, a first machine learning (ML) model of a set of ML models to the response data, the set of responses, and the plurality of queries;
generating, by the computer, a set of solutions to resolve the issue, wherein the set of solutions is generated based on the application of the first ML model to the response data, the set of responses, and the plurality of queries; and
controlling, by the computer, an execution of at least a first solution of the generated set of solutions.

2. The computer-implemented method of claim 1, further comprising:
determining, by the computer, a set of likelihood values associated with the set of solutions, wherein each likelihood value of the set of likelihood values is indicative of a likelihood of a corresponding solution of the set of solutions to resolve the set of queries;
arranging, by the computer, the generated set of solutions based on the determined set of likelihood values;
selecting, by the computer, at least the first solution of the generated set of solutions based on the arrangement; and
controlling, by the computer, the execution of at least the selected first solution of the generated set of solutions.

3. The computer-implemented method of claim 1, further comprising:
applying, by the computer, a second ML model of the set of ML models to the response data; and
identifying, by the computer, the set of queries from the plurality of queries based on the application of the second ML model to the response data, wherein a response of each query of the set of queries is absent in the received response data.

4. The computer-implemented method of claim 1, further comprising:
applying, by the computer, a second ML model of the set of ML models to the response data; and
identifying, by the computer, the set of queries from the plurality of queries based on the application of the second ML model to the response data, wherein a response, in the received response data, of each query of the set of queries is inaccurate.

5. The computer-implemented method of claim 1, further comprising:
applying, by the computer, a second ML model of the set of ML models to the plurality of queries;
determining, by the computer, a quality score associated with each query of the plurality of queries based on the application of the second ML model to the plurality of queries; and
identifying, by the computer, the set of queries from the plurality of queries based on the quality score.

6. The computer-implemented method of claim 5, further comprising:
comparing, by the computer, the quality score associated with each query of the plurality of queries with a threshold quality score; and
identifying, by the computer, the set of queries from the plurality of queries based on the comparison.

7. The computer-implemented method of claim 1, further comprising:
identifying, by the computer, a first subset of queries from the set of queries based on the retrieved domain-specific data;
applying, by the computer, a second ML model of the set of ML models to the first subset of queries and the domain-specific data; and
generating, by the computer, a first subset of responses for the first subset of queries based on the application of the second ML model to the first subset of queries and the domain-specific data, wherein the set of responses comprises the first subset of responses.

8. The computer-implemented method of claim 7, further comprising:
identifying, by the computer, a second subset of queries from the set of queries based on the retrieved domain-specific data, wherein the first subset of queries is different from the second subset of queries;
receiving, by the computer, feedback data associated with the second subset of queries; and
generating, by the computer, a second subset of responses for the second subset of queries based on the feedback data, wherein the set of responses comprises the second subset of responses.

9. The computer-implemented method of claim 1, further comprising:
retrieving, by the computer, a training dataset comprising a plurality of historical issues, and a plurality of historical solutions associated with the plurality of historical issues, wherein
each historical solution of the plurality of historical solutions is associated with a resolution of a corresponding historical issue of the plurality of historical issues,
the plurality of historical issues includes the issue, and
the plurality of historical solutions includes the set of solutions; and
training, by the computer, the first ML model based on the training dataset.

10. A computer system, comprising:
a processor set;
one or more computer-readable storage media; and
program instructions stored on the one or more computer-readable storage media, the program instructions executable by the processor set to cause the processor set to:
receive response data for a plurality of queries, wherein the plurality of queries is associated with an issue in a specific domain;
identify a set of queries from the plurality of queries based on the received response data;
retrieve domain-specific data from a set of knowledge bases associated with the specific domain, wherein the domain-specific data is retrieved based on the identification of the set of queries;
generate a set of responses for the identified set of queries, wherein the set of responses is generated based on the retrieved domain-specific data;
apply a set of machine learning (ML) models to the response data, the set of responses, and the plurality of queries;
generate a set of solutions to resolve the issue, wherein the set of solutions is generated based on the application of the set of ML models to the response data, the set of responses, and the plurality of queries; and
control an execution of at least a first solution of the generated set of solutions.

11. The computer system of claim 10, wherein the program instructions further cause the processor set to:
determine a set of likelihood values associated with the generated set of solutions, wherein each likelihood value of the set of likelihood values is indicative of a likelihood of a corresponding solution of the set of solutions to resolve the set of queries;
arrange the generated set of solutions based on the determined set of likelihood values;
select at least the first solution of the generated set of solutions based on the arrangement; and
control the execution of at least the selected first solution of the generated set of solutions.

12. The computer system of claim 10, wherein the program instructions further cause the processor set to:
apply the set of ML models to the response data; and
identify the set of queries from the plurality of queries based on the application of the set of ML models to the response data, wherein a response of each query of the set of queries is absent in the received response data.

13. The computer system of claim 10, wherein the program instructions further cause the processor set to:
apply the set of ML models to the response data; and
identify the set of queries from the plurality of queries based on the application of the set of ML models to the response data, wherein a response, in the received response data, of each query of the set of queries is inaccurate.

14. The computer system of claim 10, wherein the program instructions further cause the processor set to:
apply the set of ML models to the plurality of queries;
determine a quality score associated with each query of the plurality of queries based on the application of the set of ML models to the plurality of queries; and
identify the set of queries from the plurality of queries based on the quality score.

15. The computer system of claim 14, wherein the program instructions further cause the processor set to:
compare the quality score associated with each query of the plurality of queries with a threshold quality score; and
identify the set of queries from the plurality of queries based on the comparison.

16. The computer system of claim 10, wherein the program instructions further cause the processor set to:
identify a first subset of queries from the set of queries based on the retrieved domain-specific data;
apply the set of ML models to the first subset of queries and the domain-specific data; and
generate a first subset of responses for the first subset of queries based on the application of the set of ML models to the first subset of queries and the domain-specific data, wherein the set of responses comprises the first subset of responses.

17. The computer system of claim 16, wherein the program instructions further cause the processor set to:
identify a second subset of queries from the set of queries based on the retrieved domain-specific data, wherein the first subset of queries is different from the second subset of queries;
receive feedback data associated with the second subset of queries; and
generate a second subset of responses for the second subset of queries based on the feedback data, wherein the set of responses comprises the second subset of responses.

18. The computer system of claim 10, wherein the program instructions further cause the processor set to:
retrieve a training dataset comprising a plurality of historical issues and a plurality of historical solutions associated with the plurality of historical issues, wherein each historical solution of the plurality of historical solutions is associated with a resolution of a corresponding historical issue of the plurality of historical issues, and wherein the plurality of historical issues is inclusive of the issue and the plurality of historical solutions is inclusive of the generated set of solutions; and
train the set of ML models based on the training dataset.

19. A computer-program product for generation of a set of solutions to resolve an issue in a specific domain, the computer-program product comprising:
one or more computer-readable storage media; and
program instructions stored on the one or more computer-readable storage media to perform operations comprising:
receiving response data for a plurality of queries, wherein the plurality of queries is associated with the issue in the specific domain;
identifying a set of queries from the plurality of queries based on the received response data;
retrieving domain-specific data from a set of knowledge bases associated with the specific domain, wherein the domain-specific data is retrieved based on the identification of the set of queries;
generating a set of responses for the identified set of queries, wherein the set of responses is generated based on the retrieved domain-specific data;
applying a machine learning (ML) model to the response data, the set of responses, and the plurality of queries;
generating the set of solutions to resolve the issue, wherein the set of solutions is generated based on the application of the ML model to the response data, the set of responses, and the plurality of queries; and
controlling an execution of at least a first solution of the generated set of solutions.

20. The computer-program product of claim 19, wherein the program instructions stored on the one or more computer-readable storage media perform the operations further comprising:
determining a set of likelihood values associated with the set of solutions, wherein each likelihood value of the set of likelihood values is indicative of a likelihood of a corresponding solution of the set of solutions to resolve the set of queries;
arranging the set of solutions based on the determined set of likelihood values;
selecting at least the first solution of the set of solutions based on the arrangement; and
controlling the execution of at least the selected first solution of the generated set of solutions.
